(19) United States
(12) Patent Application Publication
(10) Pub. No.: US 2026/0358299 A1
(43) Pub. Date: Nov. 12, 2026

(54) SYSTEMS, METHODS, AND APPARATUS FOR PROVIDING INSPECTION ROBOT WITH IMPROVED RELIABILITY

(71) Applicant: Gecko Robotics, Inc., Pittsburgh, PA (US)

(72) Inventors: Mark Cho, Pittsburgh, PA (US); Kevin Y. Low, Pittsburgh, PA (US); Edwin H. Cho, Pittsburgh, PA (US); Samuel Theodore Westenberg, Portland, ME (US); Mary Grace Barrineau, Pittsburgh, PA (US); Maxwell Moore Skirpan, Wexford, PA (US); Conner T. Castle, Pittsburgh, PA (US)

(21) Appl. No.: 19/713,138

(22) Filed: Jun. 18, 2026

Related U.S. Application Data
(63) Continuation of application No. PCT/US2024/061446, filed on Dec. 20, 2024.
(60) Provisional application No. 63/612,645, filed on Dec. 20, 2023.

(51) Int. Cl. G01N 29/265; B25J 9/00; B25J 19/02; G01N 29/22

(52) U.S. Cl. CPC G01N 29/265; B25J 9/0009; B25J 19/026; G01N 29/225

(57) ABSTRACT

A system may include a main body having a housing. The system may include a payload having sled assemblies, the sled assemblies including at least one sled structured to interface with the inspection surface and to house an ultrasonic (UT) sensor for inspecting the inspection surface. The system may include at least one junction box on the payload and including assembly connectors to connect to the sled assemblies. The system may include at least one cable connected between the at least one junction box and the main body for electrical communications therebetween, the electrical communications including signals for the UT sensors housed by respective at least one sleds of the sled assemblies. The at least one junction box may be configured to route the signals for the UT sensors between the at least one cable and the assembly connectors.

### CROSS-REFERENCE TO RELATED APPLICATIONS

This application claims benefit of and is a continuation of International Patent Application No. PCT/US2024/061446 (Attorney Docket No. GROB-0020-WO), filed Dec. 20, 2024, and entitled “SYSTEMS, METHODS, AND APPARATUS FOR PROVIDING INSPECTION ROBOT WITH IMPROVED RELIABILITY,” International Pub. No. WO 2025/137562, which is hereby incorporated by reference in its entirety for all purposes.

International Patent Application No. PCT/US2024/061446 claims the benefit of U.S. Provisional Patent Application 63/612,645 (Attorney Docket No. GROB-0020-P01), filed on Dec. 20, 2023, entitled “INSPECTION ROBOT WITH IMPROVED RELIABILITY”.

U.S. patent application Ser. No. 15/853,391 (Attorney Docket No. GROB-0003-U01), filed Dec. 22, 2017, and issued Jun. 30, 2020, as U.S. Pat. No. 10,698,412, is incorporated herein by reference in its entirety.

U.S. patent application Ser. No. 16/813,701 (Attorney Docket No. GROB-0007-U01), filed Mar. 9, 2020, and issued Jun. 13, 2023, as U.S. Pat. No. 11,673,272, is incorporated herein by reference in its entirety.

U.S. patent application Ser. No. 17/716,249 (Attorney Docket No. GROB-0010-U01), filed Apr. 8, 2022, and issued Jan. 9, 2024, as U.S. Pat. No. 11,865,698, is incorporated herein by reference in its entirety.

Each of the foregoing applications is incorporated herein by reference in its entirety for all purposes.

### BACKGROUND

The present disclosure relates to an inspection robot for inspection of inspection surfaces such as industrial surfaces.

### SUMMARY

Example embodiments of the present disclosure provide cabling and communication improvements for payload packaging. Aspects thereof allow for rapid configuration of a payload for an inspection robot, ease of confirming proper configuration and sensor connection, and ease in troubleshooting issues with the payload, such as detecting connectivity issues. Further, payload packaging aspects of the present disclosure provide protection for cabling during assembly, transfer, and/or inspection operations. Further, payload packaging aspects of the present disclosure allow support for a higher sensor count on the payload, improving inspection times, inspection resolution, and/or inspection quality. Without limitation to any other aspect of the present disclosure, example aspects for cabling and communication improvements include one or more aspects such as junction boxes, chain housings, sled assembly cables, and/or cable connectors. Example embodiments may include any one or more, or all, aspects of the cabling and communication improvements. In certain embodiments, an inspection robot may not include cabling and/or communication improvements, where such embodiments may have other aspects of the present disclosure.

Example embodiments of the present disclosure include improved encoders relative to previously known systems, configured with characteristics that are more robust in an inspection robot environment. Further example embodiments include stability support for the inspection robot, which may be combined with the encoder improvements or included separately. Stability support aspects reduce any liftoff tendency from the inspection robot due to vertical acceleration, encountering obstacles or inspection surface shapes that may lift the inspection robot, improve contact of payload sensors with the inspection surface, increase the fraction of acceptable data taken from the sensors (e.g., by improving the contact time and consistency), and allow for safer operation of the inspection robot in various environments (e.g., high vertical environments). Without limitation to any other aspect of the present disclosure, example aspects for an encoder and/or stability support include an encoder having a radial read head and a ring therein, a passive biasing device to urge the encoder assembly toward the inspection surface, encoder connections to the inspection robot and/or a drive module of the inspection robot, a passive gas spring biasing device, and/or arrangements with more than one encoder and/or more than one drive module. Example embodiments may include any one or more, or all, aspects of the encoder and/or stability improvements. In certain embodiments, an inspection robot may not include encoder and/or stability improvements, where such embodiments may have other aspects of the present disclosure.

Example embodiments of the present disclosure include an inspection robot having a leak test port on the housing for convenient testing of the environmental integrity of the inspection robot housing. The leak test port is provided in a location to allow for a rapid and convenient test of the inspection robot housing without interfering with other installed aspects of the inspection robot, allowing for the leak test to be more representative of the inspection robot in actual inspection configuration, and isolating confounding factors of the leak test that may be present in a more complex leak test configuration or using a more complex leak test protocol. Inspection robots travel in environmentally challenging environments, and have sensitive electronic components that are sensitive to environmental intrusion such as water, corrosive fluids, high temperature fluids, or the like, where the intrusion integrity of the inspection robot is important to proper function, reducing intermittent failures that can be expensive to diagnose and correct, or the like. Further, inspection robots of the present disclosure typically have a minimal footprint (e.g., to reduce the size and weight of the inspection robot, and/or to ease maneuverability and positioning on the inspection surface) that is challenged with numerous components such as payloads, drive modules, multiple electronic boards, cameras, peripheral devices, etc. Still further, inspection robots of the present disclosure routinely have maintenance, configuration, and/or operational events that involve opening the inspection robot and/or connecting devices to the inspection robot, where the connections form a part of the seal for the inspection housing. Accordingly, a leak test capability that utilizes reserved space on the housing footprint that does not interfere with, or that minimizes interference with, any of the numerous components of the inspection robot, and that allows for rapid and convenient leak testing operations, is especially useful for embodiments of the present disclosure. An example leak test port is positioned at the rear of the inspection robot, and configured for coupling of a pneumatic tether with no interference with other components, and/or with minimal interference with other components.

Example embodiments of the present disclosure include a number of improvements for drive modules for inspection robots. Inspection robots of the present disclosure are configured to move autonomously (and/or through remote control) on an inspection surface, in challenging environments that may have high temperatures, water exposure, vibration, corrosive fluid exposure, or the like. Further, inspection surfaces may be varied, for example surfaces having different curvatures, concavity, undulations, obstacle presence, verticality, or the like. Accordingly, inspection robot configuration changes to swap out drive modules having different characteristics, to normalize and/or rate limit wear on components, to allow for inspection and reconditioning of drive module components, or the like, result in an inspection robot where changing drive modules may occur frequently, and/or may be performed in the field or other challenging environment. When a drive module is swapped, challenges are introduced to ensure integrity of connections and proper orientation of the drive modules, and those challenges are more acute in a field swap setting. Without limitation to any other aspect of the present disclosure, example aspects of the present disclosure for drive module improvements include swappable drive modules (e.g., drive modules that operate correctly in either side-side symmetry, front-back symmetry, or both), a robust connection port that maintains sealing after a swap, improvements to the EMI robustness of the drive module, drive module engagement width adjustments that can be applied without removing the drive module (and/or that can be readily applied in the field). Example embodiments may include any one or more, or all, aspects of the drive module improvements. In certain embodiments, an inspection robot may not include drive module improvements, for example utilizing a previously known drive module configuration, where such embodiments may have other aspects of the present disclosure.

Example embodiments herein include a number of improvements for the suspension of an inspection robot. Inspection robots of the present disclosure are configured to move autonomously (and/or through remote control) on an inspection surface, in challenging environments that may have high temperatures, water exposure, vibration, corrosive fluid exposure, or the like. Further, inspection surfaces may be varied, for example surfaces having different curvatures, concavity, undulations, obstacle presence, verticality, or the like. Accordingly, suspension improvements of the present disclosure provide for a number of benefits, including improved maintenance of surface contact and reduction of payload disturbance while moving on the surface, simplified engagement and/or swapping with drive modules, and efficient utilization of available physical space on and near the inspection robot. Without limitation to any other aspect of the present disclosure, suspension improvements include one or more aspects such as selectable distance provision between drive modules, electrical connections between the drive module and the inspection robot main body, an easily engaged stowed or deployed positioning for drive modules, and available movement degrees of freedom for the suspension assembly and coupled drive modules. Example embodiments may include any one or more, or all, aspects of the suspension improvements. In certain embodiments, an inspection robot may not include suspension improvements, where such embodiments may have other aspects of the present disclosure.

Example embodiments of the present disclosure include improvements for EMI management, including for electrical connections between drive modules and the inspection robot main body, which may include electrical connections of significant length that can act as an antenna for particular EM frequencies, interfering with control or feedback operations, disrupting electrical power, and/or disrupting proper operation of the inspection robot. In certain embodiments, tubular members of a telescoping suspension assembly can also act as an antenna for particular EM frequencies, and the relevant EM frequencies may vary, for the tubular members and/or for electrical connections therein, at different positions of the telescoping members, increasing the challenges in configuring the inspection robot to be robust to the EMI environment across applications. In certain embodiments, EM emissions from the telescoping members may additionally or alternatively be significant, where aspects described to inhibit antenna effects may instead, or in addition, be utilized to inhibit undesirable EMI from the inspection robot or components thereof. In certain embodiments, the length of the electrical connections are provided to allow for flexibility in the configuration of the inspection robot and/or to support other challenges herein. Without limitation to any other aspect of the present disclosure, EMI management improvements include one or more aspects such as EMI o-rings (e.g., electrically conductive o-rings) on a tubular member at least partially defining electrical connections coupling drive module(s) to a main body of the inspection robot, flexible electrical connections, pogo pin connections between members of a telescoping suspension assembly, redundant sealing, and/or wear management to provide predictable performance over time and controlled service and/or maintenance of the suspension assembly. Example embodiments may include any one or more, or all, aspects of the EMI management improvements. In certain embodiments, an inspection robot may not include EMI management improvements, where such embodiments may have other aspects of the present disclosure.

Example embodiments of the present disclosure include port configurations to address and/or mitigate challenges presented for inspection robots and applications therefore. Various challenges relevant to port configurations, and as described throughout the present disclosure, include interfacing with a wide variety of payloads having a variety of sensors with distinct electrical, communication, couplant, or other connection characteristics, preserving the ability to rapidly and confidently configure the inspection robot including at a field location with limited facilities, ensuring the connections are properly made that will support operations and that will resist environmental intrusion, and that are flexible to support new types of sensors and/or payloads as they become available. Without limitation to any other aspect of the present disclosure, port configuration improvements include one or more aspects such as provisions for a tether port, a couplant port, and/or sensor ports; provision for a leak test port, and/or provision for expansion ports. In certain embodiments, the ports may additionally include supporting features configured to address aspects relevant to a particular port, for example supporting lugs for a tether port, positioning of ports to accommodate the available footprint as well as considering how the ports are utilized in service (e.g., positioning the leak test port for access in view of typical payload configurations, etc.), provision on the inspection robot footprint for a camera(s) and supporting electronics and communication, relative positioning of the ports to internal structures such as relevant boards, including consideration for internal routing, power provision, heat management, and the like. Example embodiments may include any one or more, or all, aspects of the port configuration improvements. In certain embodiments, an inspection robot may not include port configuration improvements, where such embodiments may have other aspects of the present disclosure.

Example embodiments of the present disclosure include improvements to a center body (or main body) of the inspection robot to address one or more challenges as set forth herein, including at least challenges related to environmental aspects (e.g., temperature, presence of water and/or corrosive fluids, EMI environment, etc.), operational aspects (e.g., the ability to configure, adjust, and/or service the inspection robot, including in the field), and/or support for sufficient capability for varied inspections and inspection surfaces (e.g., accommodation for various payloads, drive modules, peripherals, etc.). Without limitation to any other aspect of the present disclosure, center body improvements include one or more aspects such as: accommodation (e.g., physical footprint, communication connections, electrical connections, etc.) for various ports, payloads, drive modules, and/or suspension assemblies; lid arrangements; internal board arrangements; internal heat management; internal EMI management; and/or external housing aspects to support any one or more of these. Example embodiments may include any one or more, or all, aspects of the center body improvements. In certain embodiments, an inspection robot may not include center body improvements, where such embodiments may have other aspects of the present disclosure.

Example embodiments of the present disclosure include control arrangements within the inspection robot to support various other improvements and/or to address challenges in previously known systems as set forth throughout the present disclosure. Example control arrangements herein provide for ease of configuration of the inspection robot, support varying configurations for different payloads, drive modules, peripherals, and the like to support a variety of inspection configurations, facilitate ease of configuration, service, and/or troubleshooting including in a field environment. Without limitation to any other aspect of the present disclosure, control arrangements of the disclosure herein include organizing control operations of the inspection robot onto a number of PCBs, such as: a core PCB configured to provide core processing operations such as communications to a base station, commanding DAQ operations such as starting or stopping data collection, storing data, sampling rates, and/or other DAQ parameters, receiving position or movement commands and/or providing position or movement commands to drive modules, and/or performing status or diagnostic communications; one or more drive module controller PCBs configured to control drive modules to perform movement operations (e.g., responsive to commands from the core PCB); a DAQ PCB that communicates with sensors to collect inspection data, status data, perform analog-to-digital (A/D) processing, etc.; and/or an add-on PCB configured to support auxiliary devices, peripheral devices, cameras, provide additional processing power, dedicated math and/or co-processing operations, or the like. The organization of PCBs and distribution of control responsibility supports other aspects of the present disclosure such as rapid configuration changes, and additionally or alternatively supports scaling or addition of capabilities, prototyping or testing of new control features, and/or provides isolation of faults or other issues on the inspection robot. Example embodiments may include any one or more, or all, aspects of the control organization features. In certain embodiments, an inspection robot may not include control organization features set forth herein, where such embodiments may have other aspects of the present disclosure.

Example embodiments of the present disclosure include a robot removal platform (e.g., a lift-off mat) configured to engage an inspection robot, and assist in positioning the inspection robot onto and/or removing the inspection robot from the inspection surface. The inspection robot generally attaches to the inspection surface, for example utilizing magnetic wheels or other magnetic engagement, with sufficient force to secure the inspection robot to the inspection surface, and with sufficient supplemental force to overcome traversal over debris, an abnormally thick coating section, or the like. Accordingly, surface placement and/or removal operations can be difficult, and/or involve forces or accelerations that are not desirable for comfortable user operation and/or long-term wear of the inspection robot. The example robot removal platform of the present disclosure further supports other aspects of the present disclosure, such as allowing for complex (and potentially delicate) payload arrangements to be positioned confidently on the surface, and/or to support rapid configuration changes by providing ease of placement and/or removal from the surface. Without limitation to any other aspect of the present disclosure, the example robot removal platform includes one or more aspects such as a flexible polymer mat having magnets and a metal mesh, a through-hole for accessing a suspension assembly of the inspection robot when the inspection robot is positioned on the robot removal platform, a thickness sufficient to protect the wheels or engagement surfaces of the inspection robot during placement and to reduce the attachment force of the inspection robot while still allowing the inspection robot to stay on the surface (which may include a variable or ramped thickness to allow the lift-off force to be selected by the operator), a beveled edge to accommodate inspection robot movement onto or off of the platform, a configuration of the internal metal mesh to adhere more strongly to the inspection robot than to the inspection surface (e.g., allowing the mat to be removed with the inspection robot from the surface), and/or an extended lifting edge of the platform allowing the user to easily begin lifting the platform from the inspection surface while the inspection robot is on the platform. Example embodiments may include any one or more, or all, aspects of the robot removal platform. In certain embodiments, an inspection robot may not be utilized with a robot removal platform, where such embodiments may have other aspects of the present disclosure.

In some aspects, the techniques described herein relate to an inspection robot for inspecting an inspection surface, including: a main body including a metal housing, wherein the metal housing is structured to open and close via a hinge; a suspension assembly fixed to the main body; a payload including eight sled assemblies, each of the eight sled assemblies including three sleds each structured to interface with the inspection surface and to house an ultrasonic (UT) sensor for inspecting the inspection surface, a first junction box and a second junction box each fixed to the payload; a first cable connected between the main body and the first junction box, the first cable structured to transmit signals for a first twelve UT sensors, which are respectively housed by the three sleds of each of a first through a fourth of the eight sled assemblies; a second cable connected between the main body and the second junction box, the second cable structured to transmit signals for a second twelve UT sensors, which are respectively housed by the three sleds of each of a fifth through an eight of the eight sled assemblies; a first chain housing structured to contain the first cable therein; a second chain housing structured to contain the second cable therein; wherein the first junction box includes: a first junction box connector structured to connect to the first cable; assembly connectors for each of the first through fourth sled assemblies; and a first junction box printed circuit board structured to route the signals for the first twelve UT sensors between the first cable and the respective assembly connectors for each of the first through fourth sled assemblies; wherein the second junction box includes: a second junction box connector structured to connect to the second cable; assembly connectors for each of the fifth through eighth sled assemblies; and a second junction box printed circuit board structured to route the signals for the second twelve UT sensors between the second cable and the respective assembly connectors for each of the fifth through eighth sled assemblies; first through eighth sled assembly cables each structured to each transmit the signals for three of the UT sensors between one of the assembly connectors of the first or second junction box and a respective one of the first through eighth sled assemblies; an encoder assembly structured to support the inspection robot and including: an enclosure including a radial read head therein, a wheel; a passive device to bias the wheel against the inspection surface; and a axial shaft connecting between the wheel and the enclosure to transfer rotational movement thereto for scanning by the radial read head; first through fourth drive modules each fixed to the suspension assembly, each of the first through fourth drive modules including: redundant sealing; a gear assembly; a magnetic wheel with an inside diameter structured to accommodate the gear assembly; an inrunner brushless steel motor operatively connected to the gear assembly; and a plurality of connection ports, wherein at least one of the connection ports is structured to communicate with the main body and receive power therefrom to power the inrunner brushless steel motor; wherein the first and second drive modules are on a first side of the inspection robot, and the third and fourth drive modules are on a second side of the inspection robot, and the first drive module and the third drive module are structured to attach to the payload; at least one of the second drive module or the fourth drive module structured to support the encoder assembly and communicate with the encoder assembly via at least one of the plurality of connection ports; the suspension assembly structured to fix to the first and second drive modules on the first side of the inspection robot and to the third and fourth drive modules on the second side of the inspection robot; the suspension assembly including: redundant sealing; an outer metal member; a tubular metal member structured to telescope to a selectable position and thereby provide a selectable distance between the first and second drive modules on the first side and the third and fourth drive modules on the second side; a plurality of electromagnetic interference (EMI) o-rings on the tubular metal member to mitigate EMI caused by the tubular metal member; a plurality of radial holes in the tubular metal member structured to accommodate pogo pins connecting between the tubular metal member and the outer metal member to reduce the EMI caused by the tubular metal member; and flexible cables or wirings within the tubular metal member and structured to communicate between the first through fourth drive modules and the main body; the main body including a leak test port in the metal housing structured for application of a selected pressure to an interior of the metal housing; a tether port structured to receive power and provide communication over a tether between the main body and a base station, the communication over the tether including digital sensor signals; at least one handle attached to at least one of the first and second or the third and fourth drive modules, the at least one handle structured to adjust between a stowed position and a deployed position through a spring-loaded bolt locking mechanism; the metal housing of the main body including fins to dissipate heat; the main body including, within the metal housing: an EMI sealing mechanism; a plurality of printed circuit boards; a plurality of heat pipes to distribute heat generated from the plurality of printed circuit boards to a surface of the metal housing; a data acquisition circuit included on one of the plurality of printed circuit boards on a lid side of the metal housing, wherein the data acquisition circuit includes an analog to digital converter that converts analog signals from the UT sensors to the digital sensor signals; a plurality of compression plates structured to create pressure between the lid side of the metal housing and the data acquisition circuit to wick heat from the data acquisition circuit to the metal housing; an array of thermoelectric coolers structured to wick heat from the data acquisition circuit to the metal housing; a foam member to thermally isolate between portions of different ones of the plurality of compression plates; a compute module circuit on another one of the plurality of printed circuit boards; and electromagnetic shielding between the data acquisition circuit on the one of the plurality of printed circuit boards and the another one of the plurality of printed circuit boards.

In some aspects, the techniques described herein relate to a system, including: the inspection robot; and a robot removal platform including magnets and a flexible polymer having a metal mesh therein, wherein a through-hole in the robot removal platform is structured to provide access to the suspension assembly of the inspection robot when the inspection robot is on the robot removal platform.

### BRIEF DESCRIPTION OF THE FIGURES

FIG. 1 depicts a top view of an inspection robot system in accordance with example embodiments of the present disclosure.

FIG. 2 depicts a top view of a portion of an inspection robot system in accordance with example embodiments of the present disclosure.

FIG. 3 depicts a portion of an inspection robot system in accordance with example embodiments of the present disclosure.

FIG. 4 depicts a portion of an inspection robot system in accordance with example embodiments of the present disclosure.

FIGS. 5A and 5B depict a portion of an inspection robot system in accordance with example embodiments of the present disclosure.

FIG. 6 depicts a portion of an inspection robot system in accordance with example embodiments of the present disclosure.

FIG. 7 depicts a portion of an inspection robot system in accordance with example embodiments of the present disclosure.

FIG. 8 depicts a portion of an inspection robot system in accordance with example embodiments of the present disclosure.

FIG. 9 depicts a bottom view of an inspection robot system in accordance with example embodiments of the present disclosure.

FIG. 10 depicts a portion of a bottom view of an inspection robot system in accordance with example embodiments of the present disclosure.

FIG. 11 depicts a portion of an inspection robot system in accordance with example embodiments of the present disclosure.

FIGS. 12A-12C depict a drive module of an inspection robot system in accordance with example embodiments of the present disclosure.

FIG. 13 depicts a cross section of a drive module and a portion of an encoder assembly of an inspection robot system in accordance with example embodiments of the present disclosure.

FIGS. 14A-14B depict a portion of a drive module of an inspection robot system in accordance with example embodiments of the present disclosure.

FIG. 15 depicts a side view of a portion of an inspection robot system in accordance with example embodiments of the present disclosure.

FIG. 16A depicts a perspective view of an encoder assembly of an inspection robot system in accordance with example embodiments of the present disclosure.

FIG. 16B depicts a perspective view of a portion of an encoder assembly of an inspection robot system in accordance with example embodiments of the present disclosure.

FIG. 17 depicts a cross section of drive modules and a suspension assembly of an inspection robot system in accordance with example embodiments of the present disclosure.

FIG. 18 depicts a cross section of drive modules and a suspension assembly of an inspection robot system in accordance with example embodiments of the present disclosure.

FIG. 19 depicts a cross section of a portion of a suspension assembly of an inspection robot system in accordance with example embodiments of the present disclosure.

FIG. 20 depicts a cross section of drive modules and a suspension assembly of an inspection robot system in accordance with example embodiments of the present disclosure.

FIG. 21 depicts a cross section of a portion of a suspension assembly of an inspection robot system in accordance with example embodiments of the present disclosure.

FIG. 22 depicts a cross section of a suspension assembly connection port connected to a drive module connection port of an inspection robot system in accordance with example embodiments of the present disclosure.

FIG. 23 depicts a cross section of a portion of a suspension assembly of an inspection robot system in accordance with example embodiments of the present disclosure.

FIG. 24 depicts a cross section of a portion of a suspension assembly of an inspection robot system in accordance with example embodiments of the present disclosure.

FIG. 25 depicts a cross section of a portion of a suspension assembly of an inspection robot system in accordance with example embodiments of the present disclosure.

FIG. 26 depicts a portion of a suspension assembly of an inspection robot system in accordance with example embodiments of the present disclosure.

FIGS. 27A and 27B depict a handle of an inspection robot system in accordance with example embodiments of the present disclosure.

FIG. 28 depicts a handle of an inspection robot system in accordance with example embodiments of the present disclosure.

FIGS. 29A and 29B depict portions of an opened main body of an inspection robot system in accordance with example embodiments of the present disclosure.

FIG. 30 depicts an opened main body of an inspection robot system in accordance with example embodiments of the present disclosure.

FIG. 31 depicts a cross section of a portion of a main body of an inspection robot system in accordance with example embodiments of the present disclosure.

FIG. 32 depicts a cross section of a portion of a main body of an inspection robot system in accordance with example embodiments of the present disclosure.

FIG. 33 depicts a main body of an inspection robot system in accordance with example embodiments of the present disclosure.

FIG. 34 depicts portions of an interior of a main body of an inspection robot system in accordance with example embodiments of the present disclosure.

FIG. 35 depicts portions of an interior of a main body of an inspection robot system in accordance with example embodiments of the present disclosure.

FIG. 36 depicts portions of an interior of a main body of an inspection robot system in accordance with example embodiments of the present disclosure.

FIG. 37 depicts a top view of a lower section of a main body of an inspection robot system in accordance with example embodiments of the present disclosure.

FIG. 38 depicts a portion of an inspection robot system in accordance with example embodiments of the present disclosure.

FIG. 39 depicts a portion of an inspection robot system in accordance with example embodiments of the present disclosure.

FIG. 40 depicts a main body and a couplant tube of an inspection robot system in accordance with example embodiments of the present disclosure.

FIG. 41 depicts a robot removal platform of an inspection robot system in accordance with example embodiments of the present disclosure.

FIG. 42 depicts a portion of an inspection robot system in accordance with example embodiments of the present disclosure.

FIG. 43 depicts a portion of an inspection robot system in accordance with example embodiments of the present disclosure.

FIG. 44 depicts an inspection robot system including a pneumatic pressuring device in accordance with example embodiments of the present disclosure.

FIG. 45 depicts a method for leak testing an inspection robot in accordance with example embodiments of the present disclosure.

FIG. 46 depicts a method for leak testing an inspection robot in accordance with example embodiments of the present disclosure.

FIG. 47 depicts a method of replacing a drive module of an inspection robot system in accordance with example embodiments of the present disclosure.

FIG. 48 depicts a method of removing an inspection robot from an inspection surface in accordance with example embodiments of the present disclosure.

FIG. 49 depicts a block diagram of portions of an inspection robot system in accordance with example embodiments of the present disclosure.

FIG. 50 depicts a method for changing drive functionalities of an inspection robot system in accordance with example embodiments of the present disclosure.

FIG. 51 depicts a side cross-section view of a portion of a lid of an inspection robot in accordance with example embodiments of the present disclosure.

FIG. 52 depicts a side cross-section view of a portion of a lid of an inspection robot in accordance with example embodiments of the present disclosure.

FIG. 53 depicts a top view inside a lid of an inspection robot in accordance with example embodiments of the present disclosure

### DETAILED DESCRIPTION

The present disclosure relates to a system developed for traversing, climbing, or otherwise traveling over walls (curved or flat), or other industrial surfaces. Industrial surfaces, as described herein, include any tank, pipe, housing, or other surface utilized in an industrial environment, including at least heating and cooling pipes, conveyance pipes or conduits, and tanks, reactors, mixers, or containers. In certain embodiments, an industrial surface is ferromagnetic, for example including iron, steel, nickel, cobalt, and alloys thereof. In certain embodiments, an industrial surface is not ferromagnetic.

Certain descriptions herein include operations to inspect a surface, an inspection robot or inspection device, or other descriptions in the context of performing an inspection. Inspections, as utilized herein, should be understood broadly. Without limiting any other disclosures or embodiments herein, inspection operations herein include operating one or more sensors in relation to an inspected surface, electromagnetic radiation inspection of a surface (e.g., operating a camera) whether in the visible spectrum or otherwise (e.g., infrared, UV, X-Ray, gamma ray, etc.), high-resolution inspection of the surface itself (e.g., a laser profiler, caliper, etc.), performing a repair operation on a surface, performing a cleaning operation on a surface, and/or marking a surface for a later operation (e.g., for further inspection, for repair, and/or for later analysis). Inspection operations include operations for a payload carrying a sensor or an array of sensors (e.g. on sensor sleds) for measuring characteristics of a surface being traversed such as thickness of the surface, curvature of the surface, ultrasound (or ultra-sonic) measurements to test the integrity of the surface and/or the thickness of the material forming the surface, heat transfer, heat profile/mapping, profiles or mapping any other parameters, the presence of rust or other corrosion, surface defects or pitting, the presence of organic matter or mineral deposits on the surface, weld quality and the like. Sensors may include magnetic induction sensors, acoustic sensors, laser sensors, LIDAR, a variety of image sensors, and the like. Example embodiments may be described with reference to ultrasonic sensors, it being understood that embodiments are not limited thereto. The inspection sled may carry a sensor for measuring characteristics near the surface being traversed such as emission sensors to test for gas leaks, air quality monitoring, radioactivity, the presence of liquids, electro-magnetic interference, visual data of the surface being traversed such as uniformity, reflectance, status of coatings such as epoxy coatings, wall thickness values or patterns, wear patterns, and the like. The term inspection sled may indicate one or more tools for repairing, welding, cleaning, applying a treatment or coating the surface being treated. Treatments and coatings may include rust proofing, sealing, painting, application of a coating, and the like. Cleaning and repairing may include removing debris, sealing leaks, patching cracks, and the like. The term inspection sled, sensor sled, and sled may be used interchangeably throughout the present disclosure.

In certain embodiments, for clarity of description, a sensor is described in certain contexts throughout the present disclosure, but it is understood explicitly that one or more tools for repairing, cleaning, and/or applying a treatment or coating to the surface being treated are likewise contemplated herein wherever a sensor is referenced. In certain embodiments, where a sensor provides a detected value (e.g., inspection data or the like), a sensor rather than a tool may be contemplated, and/or a tool providing a feedback value (e.g., application pressure, application amount, nozzle open time, orientation, etc.) may be contemplated as a sensor in such contexts.

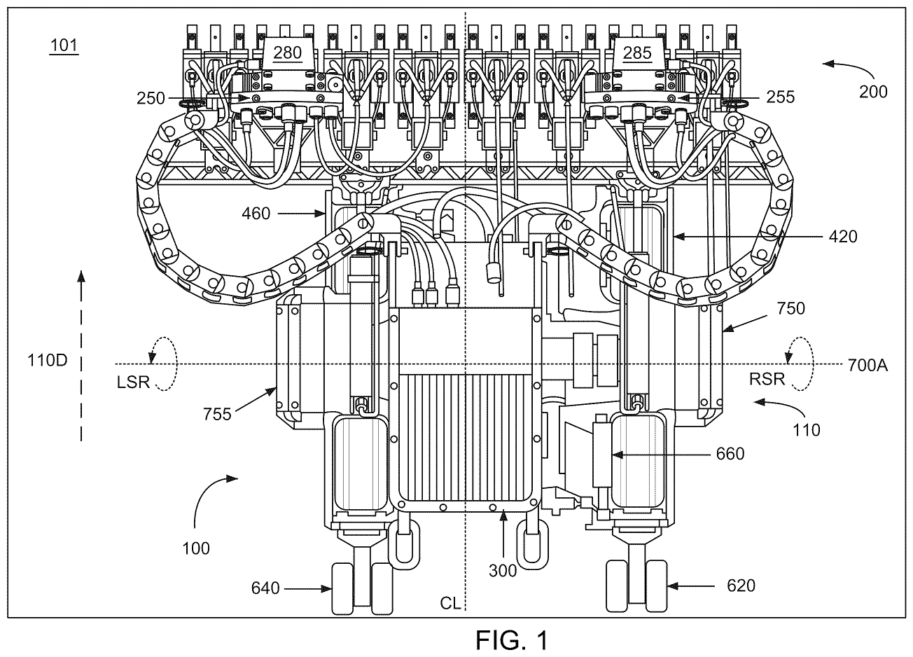

With reference to FIG. 1, example embodiments of an inspection robot system 100 (which may also be referred to herein as a robotic system) for inspecting an inspection surface 101 may include an inspection robot 110 having a payload 200. In some embodiments, as described by example herein, the payload 200 may be considered a part of the inspection robot 110. However, embodiments are not limited thereto, and in some embodiments, the inspection robot 110 may be separate from the payload 200. As described with reference to example embodiments herein, the payload 200 may detach from drive modules of the inspection robot 110, such as the front drive modules 420 and 460, to thereby detach from the remainder of the inspection robot 110. While described in some example embodiments as ‘a’ payload 200, it should be understood that ‘a’ may refer to one or more, and the payload 200 may include one or more payloads, including, in some examples, a plurality of payloads.

In some embodiments, the inspection robot system 100 may include a main body 300 including a housing 303. The housing 303 may include circuitry therein, as described with reference to example embodiments herein. In some embodiments, the housing 303 may be metal and may be described as a metal housing 303. In some embodiments, as illustrated in FIG. 1, the payload 200 may be on a front side of the main body 300 relative to a travel direction 110D of the inspection robot 110 as indicated by the arrow.

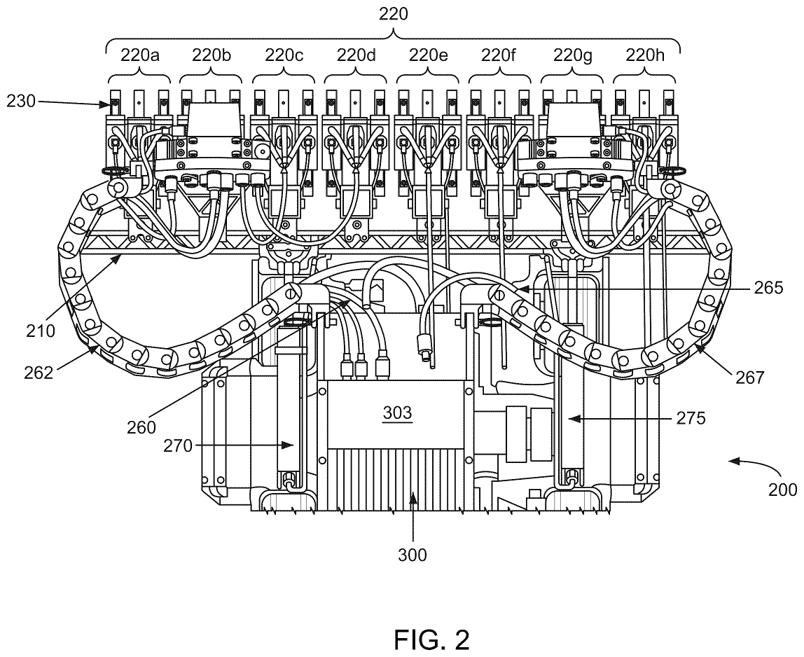

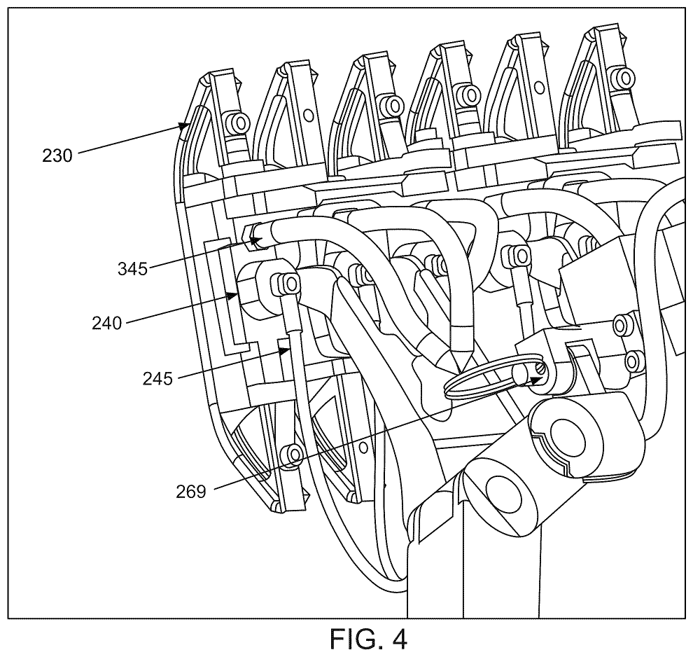

With reference to FIG. 2, according to example embodiments, the payload 200 may include a support rail 210. Also, the payload 200 may include a plurality of sled assemblies 220, which may also be referred to in example embodiments as sensor sled assemblies 220. In an example, a plurality of sensor sled assemblies 220 (e.g., 220a to 220h) may be attached to the support rail 210. Each sensor sled assembly 220 may include one or a plurality of sensor sleds 230. Each sensor sled 230 may include (e.g., house or otherwise mount) one or more sensors 240 (see, e.g., FIG. 4). In some embodiments, the one or more sensors 240 may be ultrasonic (UT) sensors, although embodiments are not limited thereto. In one example, the one or more sensors may include 10 MHz spherically focused ⅛^{th} inch element ultrasonic transducers.

Thus, for example, the sled assemblies 220 may include at least one sled (e.g., a sensor sled) 230 structured to interface with the inspection surface and to house an ultrasonic (UT) sensor 240 for inspecting an inspection surface 101. In some examples, as illustrated in FIGS. 1-2, each sled assembly may include three sleds 230, each sled 230 including a sensor 240. Thus, some embodiments may include at least one payload 200 including (e.g., via the sled assemblies 220, which are a part of the payload 200) a plurality of UT sensors 240. As illustrated in FIG. 1, in some embodiments, the system 100 may include at least one payload 200 including the plurality of ultrasonic (UT) sensors 240 on a front side of the main body 300 (e.g., relative to a travel direction 110D) for inspecting the inspection surface 101.

While example embodiments are described with reference to the inclusion of sensor sled assemblies 220, embodiments are not limited thereto, and in some embodiments, the sensor sleds 230 may, for example, individually attach to the support rail 210 rather than via respective sled assemblies 220.

In some embodiments, the spacing between sensor sleds 230 and/or sensor sled assemblies 220 may be adjustable to adjust an inspection resolution and/or inspection lane(s) (such as for pipes) of the sensors 240. For example, the sensor sled assemblies 220 may clamp or otherwise attach to the support rail 210 with a clamp or other structure that may be loosened and tightened such that the sled assemblies 220 may be moved along the support rail 210 in a horizontal direction (e.g., perpendicular to the travel direction 110D). Likewise, in embodiments without sensor sled assemblies 220, the sensor sleds 230 may individually clamp or otherwise attach to the support rail 210 with a clamp or other structure that may be loosened and tightened such that the sensor sleds 230 may be individually moved along the support rail 210 in the horizontal direction.

In some embodiments, the inspection robot 110 may include an automated structure for adjusting the spacing between sensor sled assemblies 220 and/or sensor sleds 230. The sensors 240 may each provide inspection data to a main body 300, and a spacing of the sensors 240 may define a horizontal resolution of that inspection data.

The example embodiment illustrated in FIG. 2 includes eight sensor sled assemblies 220 and three sensor sleds 230 per sled assembly 220, but embodiments are not limited thereto. In example embodiments, the number of sensor sleds 230 per sled assembly 220 and/or the number of sled assemblies 220 may be selected based on a density of the sensor sleds 230 (e.g., a physical size of each sensor sled 230, which may determine how densely they can be positioned), a size and/or shape of the inspection surface 101 to be inspected, a desired inspection resolution (as may be determined by a density of the sensors 240 and the spacing therebetween), a quantization of features of an inspection surface as they relate to a number of sled assemblies 220 distributed to fit on such features (e.g., the tops of boiler pipes), limitations on uniform couplant delivery to sensors 240 of the sensor sleds 230, limitations on the ability of inspection robot 110 to handle inspection data (e.g., limitations of an analog-to-digital converter receiving analog inspection data from the sensors 240), and/or other considerations.

For example, in some embodiments, uniform couplant fluid delivery may become more difficult if the payload 200 includes more than around twenty-four sensors 240. And in some embodiments, an analog-to-digital converter of the inspection robot 110 may be able to handle up to thirty-two sensor 240 signals. For some common inspection surfaces, such as common boiler pipe configurations, and in view of the dimensions of the inspection robot 110 and payload 200, twenty-four sensors 240 arranged in groups of three sensors sleds 230 per sled assembly 220 may adequately inspect the inspection surface. Additionally, in an example where each sled assembly 220 provides a radius of curvature for its sleds 230 (e.g., corresponding to a curvature of an inspection surface such as a pipe), three sleds 230 may be advantageous for biasing the sled assembly 220 against opposing sides of the curved surface with two of the sleds 230. However, embodiments are not limited thereto. Example embodiments may support any number of sensors 240 subject to possible constraints such as (but not limited to) the examples described herein.

In example embodiments, the robotic system 100 may include a plurality of junction boxes, which in some embodiments may be a part of the payload 200 or on the payload 200. In an example, at least one junction box may be on the payload 200. The example embodiment of FIG. 1 illustrates two junction boxes 250 and 255, but embodiments are not limited thereto.

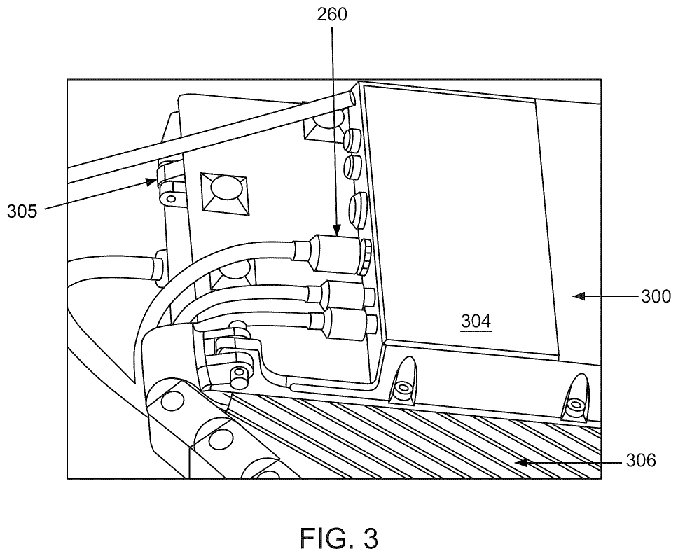

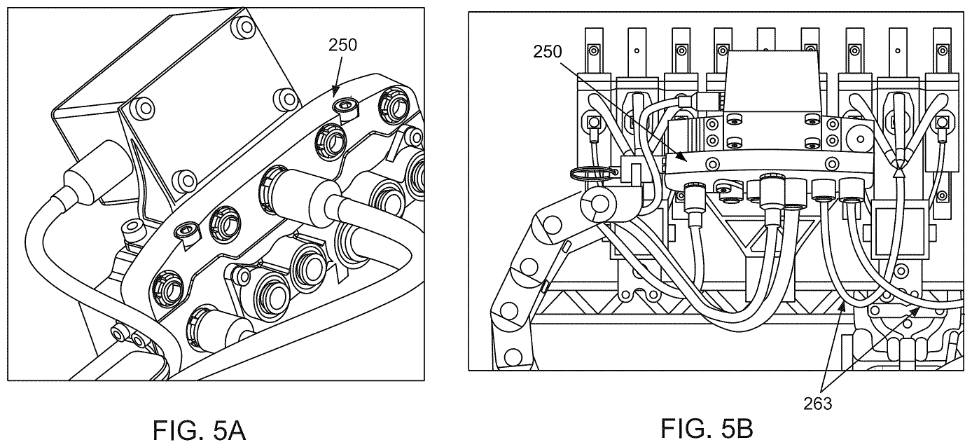

The inspection robot 110 may include respective cables connecting between the main body 300 and each of the junction boxes 250 and 255 for electrical communications therebetween. With reference to FIG. 2, in some embodiments, at least one cable 260, 265 may be connected between at least one junction box 250, 255 and the main body 300 for electrical communications therebetween. The electrical communications may include signals for the UT sensors 240 housed by respective at least one sleds 230 of the plurality of sled assemblies 220. For example, in the example embodiment illustrated in FIG. 1, the inspection robot 110 may include a first main cable 260 (see FIGS. 2-3) connecting between a port on the main body 300 and the first junction box 250, and a second main cable 265 connecting between another port on the main body 300 and the second junction box 255. Each of the main cables may transmit at least twelve signals—for example, twelve electrical signals between the sensors 240 and the main body 300. FIGS. 5A-5B provide perspective views of the junction box 250 according to an example embodiment.

With reference to FIG. 2, example embodiments may include at least one chain housing 262, 267 structured to contain the at least one cable 260, 265 therein. For example, flexible chain housings 262 and 267 may respectively house the first and second main cables 260 and 265 connecting between the main body 300 and the first and second junction boxes 250 and 255. The chain housings 262 and 267 may be flexible and may each include a sequence of rectangular chain links, which may be connected via pivot connections and structured to house or otherwise contain therein one or more of the main cables 260 and 265. The pivot connections, which may be provided at both ends of each link and structured so as not to obstruct the main cable running within the chain housing, may be tight enough that the chain housings generally maintain their shape under gravity, water, and other forces experienced during an inspection, while allowing for adjustment of the chain housings by an operator. With reference to FIG. 4, each chain housing 262 and 267 may be fixed to respective junction box 250 and 255 at a joint 269.

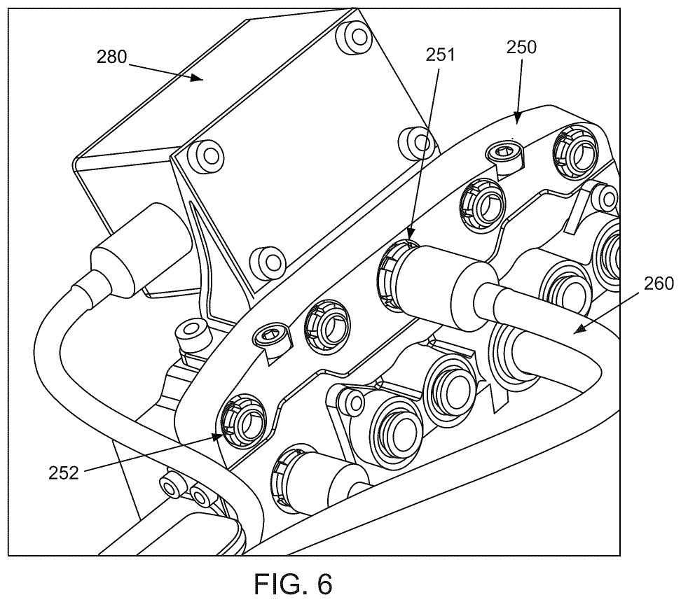

Some embodiments may include at least one junction box 250, 255 on the payload 200, which may include a plurality of assembly connectors 252 to connect to the plurality of sled assemblies 220. For example, each junction box 250 and 255 may include, for example, five connectors, including a connector 251 structured to connect to at least one of respective main cables 260 and 265 for transmitting signals including inspection data between the sensors 240 and the main body 300, and, for example, four assembly connectors 252 structured to connect to each of the respective sled assemblies 220. For example, with reference to FIG. 6, junction box 250 may include a connector 251 structured to connect to main cable 260, and four assembly connectors 252 structured to connect to first through fourth sled assemblies 220a-220d (see FIG. 1).

In some embodiments, a plurality of sled assembly cables 263 may each be structured to transmit signals for respective ones of the UT sensors 240 between one of the assembly connectors 252 of the at least one junction box 250, 255 and a respective one of the plurality of sled assemblies 220a-220d. For example, the four assembly connectors 252 may connect to the first through fourth sled assemblies 220a-220d through four respective sled assembly cables 263, which each houses (e.g., transmits) three signals for the respective sensors 240 of its three sleds 230 that are distributed to the sensors 240 of the respective sensor sleds 230 via individual sensor sled wirings 245 (see FIG. 4). However, in other examples, the individual sensor sled wirings 245 may connect to the junction boxes 250 and 255 without sled assembly cables (e.g., directly).

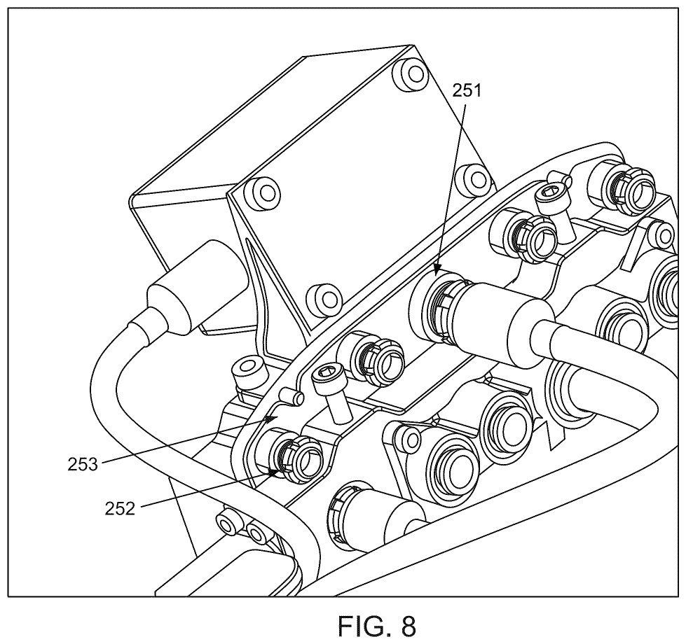

For improved reliability, in some embodiments, the junction boxes such as junction boxes 250 and 255 may include direct electrical connections (e.g., without switches) between the connector 251 and the assembly connectors 252. For example, with reference to junction box 250 as illustrated in FIG. 8, the junction boxes according to example embodiments may each include a printed circuit board (PCB) 253, which includes traces between the connector 251 and the assembly connectors 252. Thus, in an example, the PCB 253 may provide direct electrical connections between at least one cable 260 or 265 (via connector 251) and the plurality of assembly connectors 252. In an example, the PCB 253 may include three traces between each of the assembly connectors 252 and the connector 251 for transmitting signals between the respective sensors 240 of the respective sleds 230 in the sled assemblies 220 and the first main cable 260 (and thereafter, to the main body 300). Thus, in an example, at least one junction box 250, 255 may be configured to route the signals for the UT sensors 240 between the at least one main cable 260, 265 (e.g., via connector 251) and the plurality of assembly connectors 252. The PCB 253 may also provide shared grounding between the first main cable 260 and the sled assembly cables.

In some examples, the at least one junction box 250, 255 may route the signals for the UT sensors 240 according to a routing ratio parameter. For example, the routing ratio parameter may be the number of assembly connectors 252 routed to one main cable 260 or 265 (e.g., via a single connector 251). In one example, the routing ratio parameter may be one main cable to four assembly connectors.

In an example embodiment as illustrated in FIG. 1, there may be two junction boxes 250 and 255, and each junction box may support twelve sensors (e.g., via four sled assemblies 220 and respective sleds 230). However, embodiments are not limited thereto, and the number of sled assemblies connected to a junction box, as well as the number of sleds and sensors therein, may vary as described with reference to example embodiments herein.

The chain housings, main cables, assembly cables, and junction boxes as described by example herein may protect the wiring between sensors 240 and main body 300, allow for consistent routing, and prevent excess movement of cable wiring that could otherwise lead to wear and tear and thereby enhancing reliability. For example, by including main cables that each house twelve sensor signals, the number of wires between the main body 300 and the payload 200 may be reduced by 12:1.

In some embodiments, the inspection robot system 100 may include two structurally identical sets of some components. For example, with reference to FIG. 1, in an example embodiment, the inspection robot system 100 may include a plurality of sled assemblies 220a-220h (which may be collectively referred to herein as sled assemblies 220) including a first plurality of sled assemblies (e.g., sled assemblies 220a-220d) and a second plurality of sled assemblies (e.g., sled assemblies 220e-220h), and at least one junction box including a first junction box 250 and a second junction box 255. At least one cable may be included, which may include a first cable 260 connected between the main body 300 and the first junction box 250. The first cable 260 may be structured to transmit signals for a first plurality of the UT sensors 240, which may be respectively housed by a first plurality of sleds 230 of the first plurality of sled assemblies 220 (e.g., sled assemblies 220a-220d). Furthermore, the at least one cable may include a second cable 265 connected between the main body 300 and the second junction box 255. The second cable 265 may be structured to transmit signals for a second plurality of the UT sensors 240, which may be respectively housed by a second plurality of sleds 230 of the second plurality of sled assemblies 220 (e.g., sled assemblies 220e-220h).

Furthermore, in this example embodiment, the first junction box 250 may include a first junction box connector 251 structured to connect to the first cable 260, assembly connectors 252 for each of the first plurality of sled assemblies 220 (e.g., 220a-220d), and a first junction box printed circuit board 253 structured to route the signals for the first plurality of the UT sensors 240 between the first cable 260 and the respective assembly connectors 252 for each of the first plurality of sled assemblies 220. The second junction box 255 may include includes a second junction box connector 251 structured to connect to the second cable 265, assembly connectors 252 for each of the second plurality of sled assemblies 220 (e.g., 220e-220h), and a second junction box printed circuit board 253 structured to route the signals for the second plurality of the UT sensors 240 between the second cable 265 and the respective assembly connectors 252 for each of the second plurality of sled assemblies 220.

Additionally, in an example of this example embodiment, the first plurality of sleds 230 may includes twelve sleds, and the second plurality of sleds 230 may include twelve sleds. The first plurality of sled assemblies 220 may include four sled assemblies 220a-220d each having three sleds 230, and the second plurality of sled assemblies 220 may include four sled assemblies 220e-220h each having three sleds 230.

In example embodiments, the inspection robot 110 may include one or more front cameras. For example, with reference to FIG. 1, the inspection robot may include two front cameras 280 and 285. The front cameras 280 and 285 may be connected to (e.g., mounted to) or otherwise proximate to respective junction boxes 250 and 255. The front cameras 280 and 285 may move with payload 200 and may be considered a part of the payload 200.

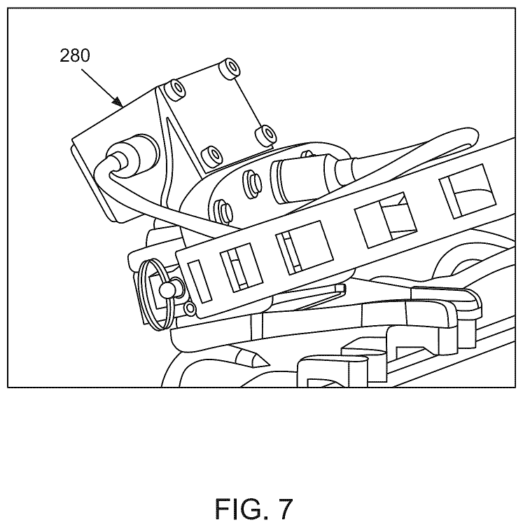

The front cameras 280 and 285 may be connected (e.g., electrically for power and communications) to main body 300 through respective cables, which may run through chain housings 262 and 267. In one example, each camera 280 and 285 may be a 1080 p USB 3.0 camera. By having the front cameras 280 and 285 in close proximity to the sensor sleds 230 (e.g., directly above them, and/or with light bars therebetween), latency may be improved. Indeed, in some embodiments, the front cameras 280 and 285 may provide low latency imaging dedicated to the respective groups of sensors served by junction boxes 250 and 255. In some embodiments, the front cameras 280 and 285 may be used by the inspection robot 110 for driving the inspection robot 110 and/or collecting images. FIG. 7 illustrates a perspective view of front camera 280 according to an example embodiment.

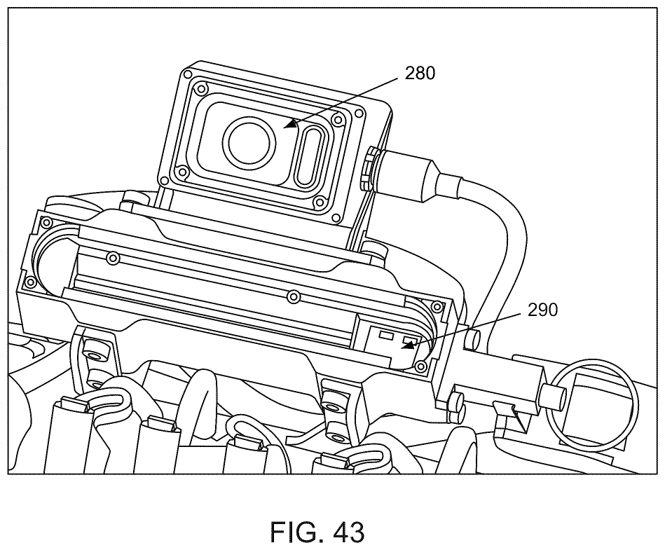

In some embodiments, with reference to FIGS. 42-43, the inspection robot 110 may include one or more light bars 290 in proximity to the cameras 280 and 285 to thereby illuminate the inspection surface for the cameras 280 and 285. By having the light bar(s) 290 and cameras 280 and 285 relatively close to the inspection surface, imperfections in the inspection surface may be more easily detected.

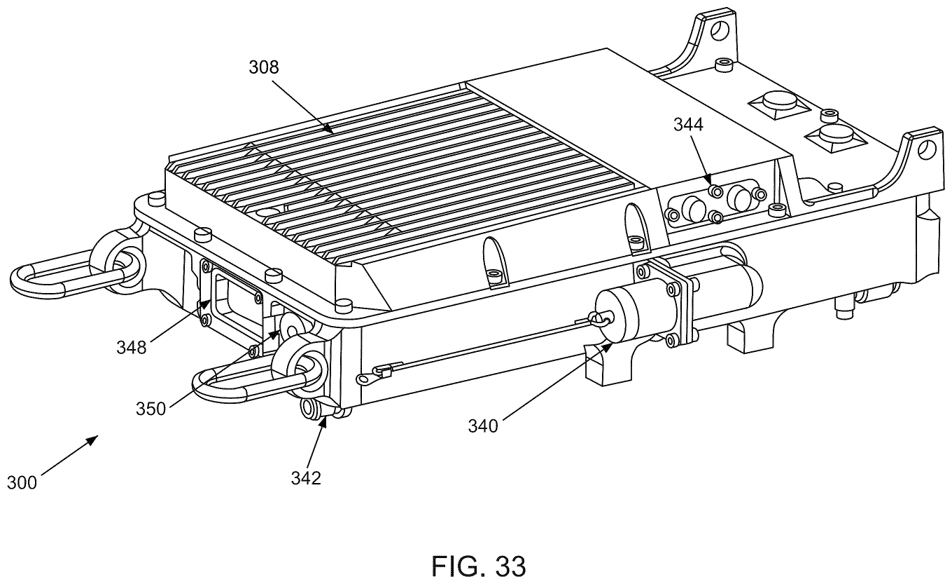

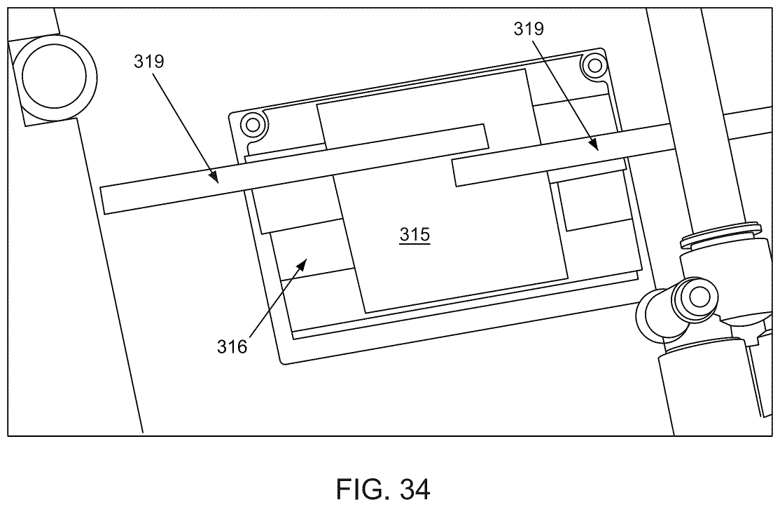

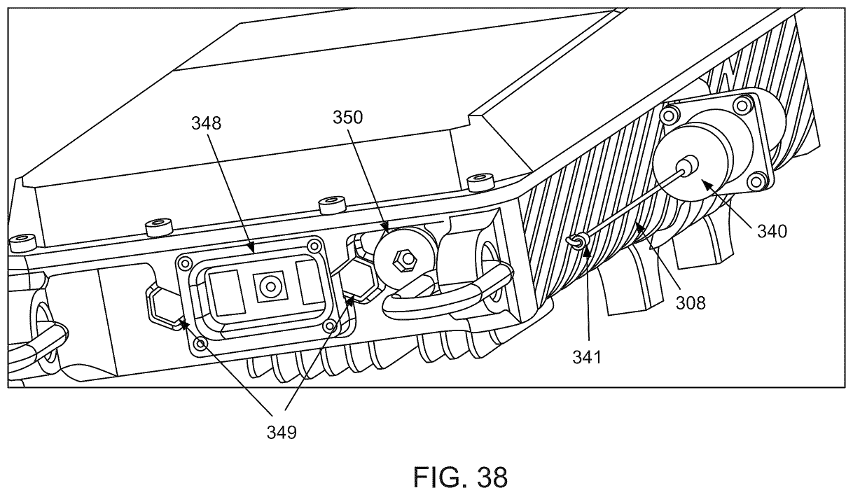

With reference to FIGS. 33 and 38, in example embodiments, the inspection robot 110 may include a rear camera 348, which may be structured to connect to a rear camera interface in main body 300. The rear camera 348 may include a customized printed circuit board (PCB) and/or printed circuit board assembly (PCBA) that integrates with a PCB and/or PCBA of main body 300. The rear camera 348 and/or the main body 300 may include one or more light components (e.g., light emitting diodes) 349 to provide light for the rear camera 348, and/or to provide a visual indication of a state of the inspection robot 110. In one example, the rear camera 348 may use the Gigabit Multimedia Serial Link (GMSL) technology. The rear camera 348 may provide improved visibility at the rear of the inspection robot as well as lower latency.

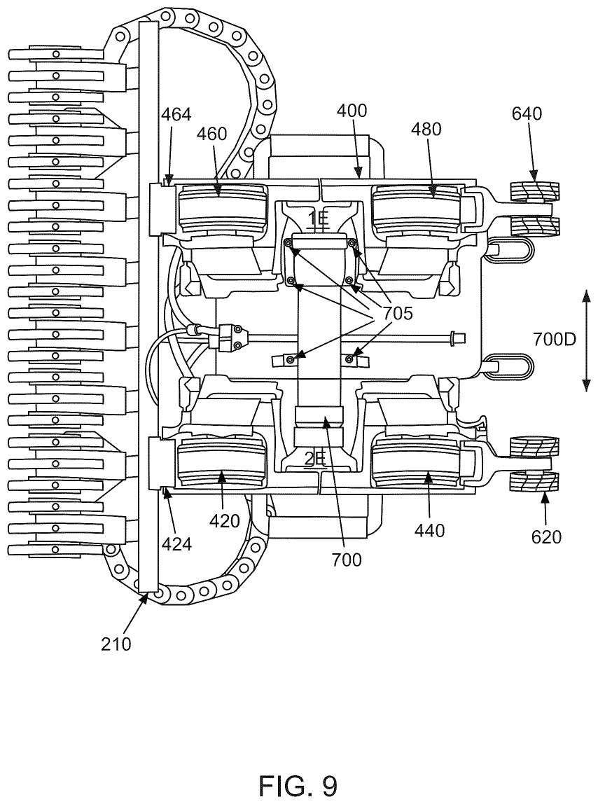

In example embodiments, the inspection robot 110 may include a drive system 400 that may include one or more drive modules. For example, with reference to FIG. 9, which shows an underside of the inspection robot 110 (e.g., a side facing the inspection surface), the drive system 400 may include four drive modules, which may include a first drive module 420, a second drive module 440, a third drive module 460, and a fourth drive module 480.

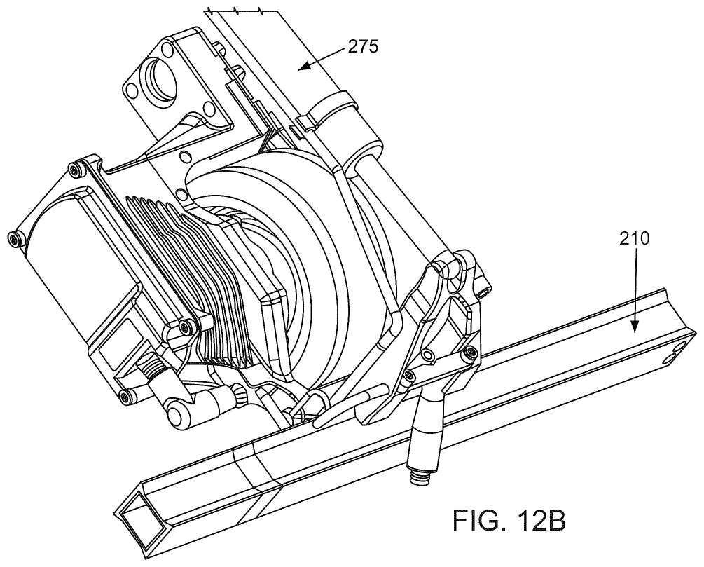

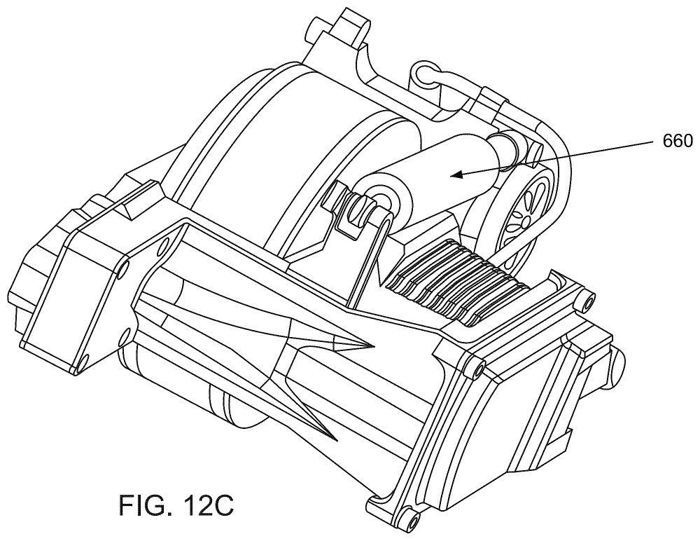

In some embodiments, each drive module may be interchangeable with each other and may include identical or similar components therein (e.g., identical or similar “cores”), but may interface with different external components. Thus, in some embodiments, the inspection robot 110 may include a plurality of interchangeable drive modules. For example, the first drive module 420 and third drive module 460 may attach to the support rail 210 of the payload 200 (see FIG. 12B), and the second drive module 440 and the fourth drive module 480 may attach to respective encoders 620 and 640 and/or gas springs used to keep respective encoders 620 and 640 in engaged positions against the inspection surface, as described herein. In some embodiments, the first drive module 420 and third drive module 460 may attach to the support rail 210 via respective clamping devices 424 and 464, as shown by example in FIG. 9. The clamping devices may, for example, include brackets that clamp to the support rail 210 via a tightening mechanism such as a screw or bolt. The clamping devices 424 and 464 may be loosened to adjust the position of the first and third drive modules 420 and 460 on the support rail 210.

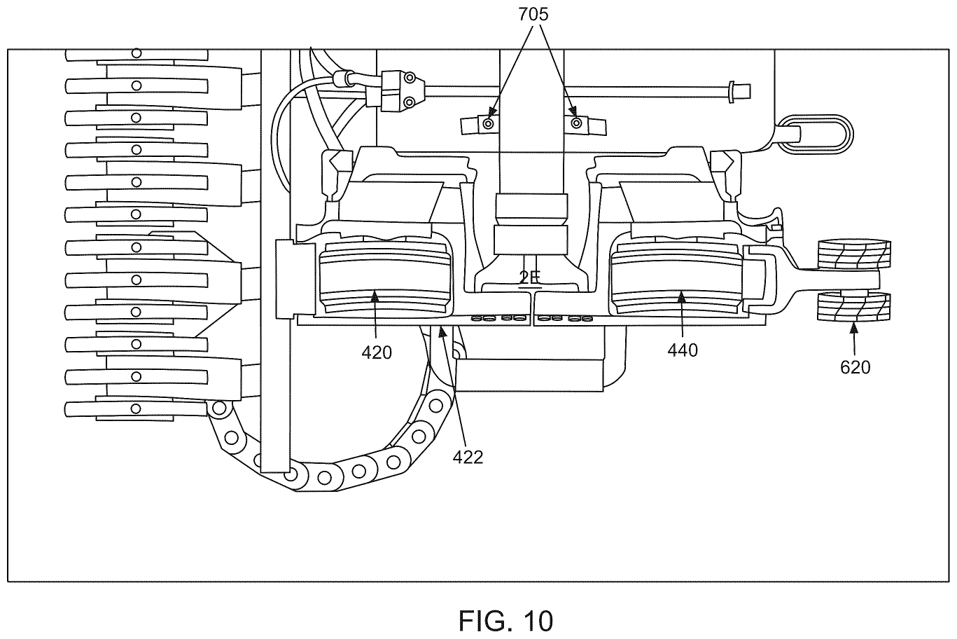

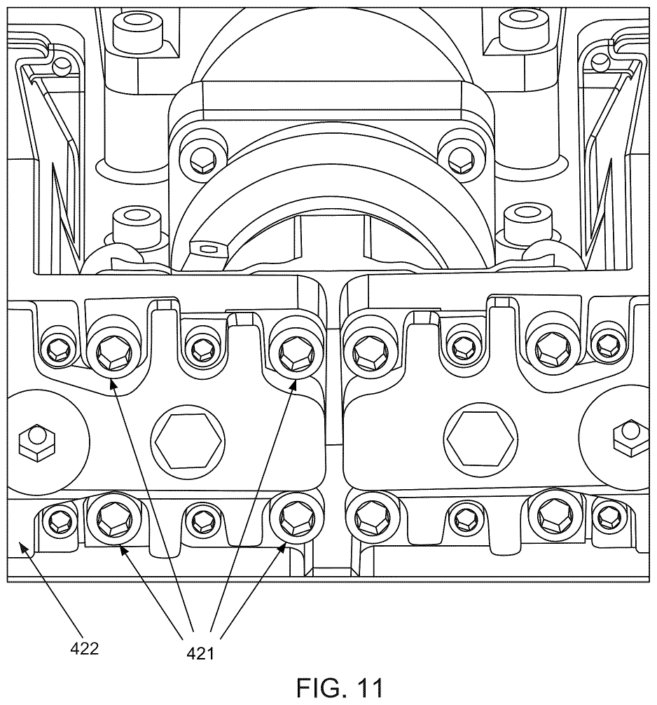

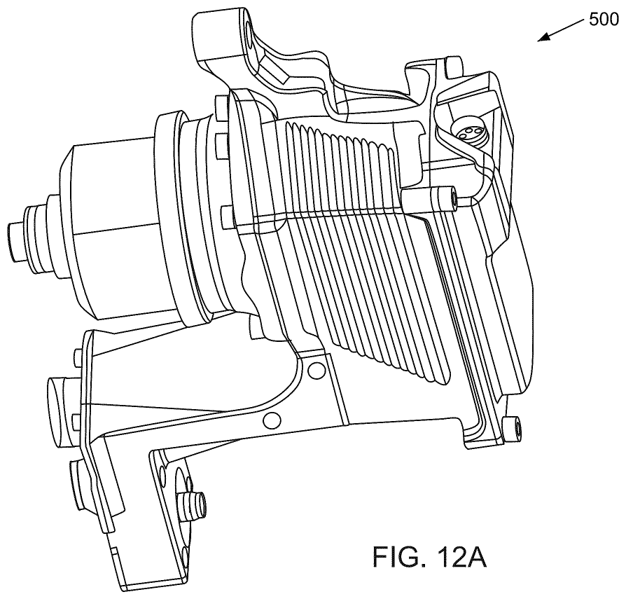

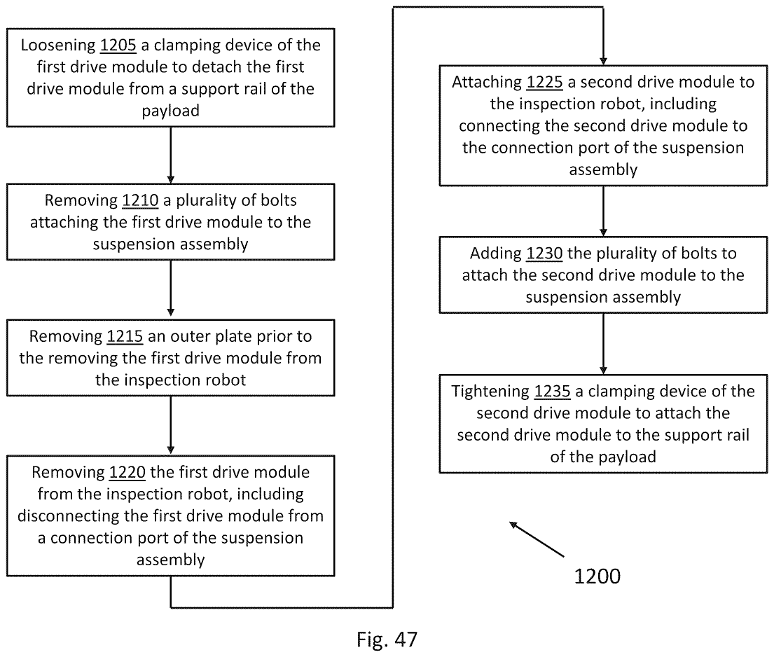

The use of interchangeable drive modules may provide enhanced modularity. Additionally, the use of interchangeable drive modules may provide enhanced reliability, since each drive module may respond similarly to wear and tear and thereby provide greater predictability in determining the need for (and what type of) maintenance or replacement. Also, the use of four drive modules each driving its own wheel (as discussed herein) may allow for a lower cost in replacing a drive module when a fault occurs. Indeed, each drive module may be separately replaceable. For example, with reference to FIGS. 10-11, first drive module 420 may be swapped by the use of bolts 421 attaching it to suspension assembly 700 and the removal of an outer plate 422. An example method of replacing a drive module according to an example embodiment will be described herein with reference to FIG. 47.

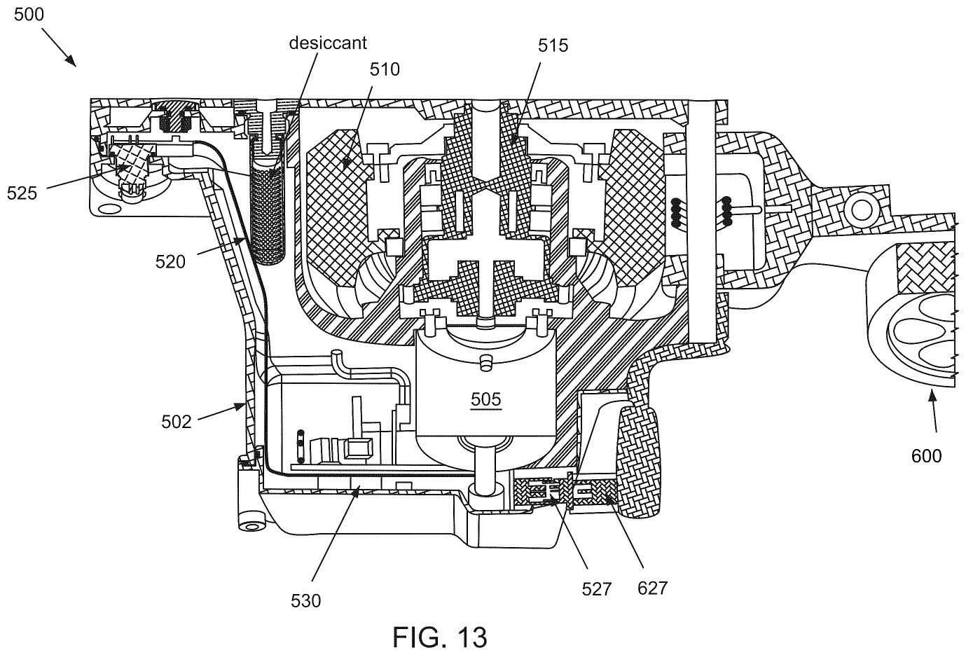

An example drive module 500 is shown in FIG. 12A, which in example embodiments may represent any one of the interchangeable drive modules including the first through fourth drive modules described for example embodiments herein. Meanwhile, FIG. 13 shows a cross-section of drive module 500 (and part of an attached encoder) according to an example embodiment. With reference to FIG. 13, the drive module 500 may include, within a housing 502 and among other components, a motor 505, a wheel 510, a gear assembly 515, a flexible PCB and/or PCBA 520, and a controller PCBA 530. The wheel 510 may be a magnetic wheel with an inside diameter structured to accommodate the gear assembly 515. In some embodiments, each drive module 500 (e.g., drive modules 420, 440, 460, 480) may include only one wheel 510, but embodiments are not limited thereto, and in other embodiments, one or more of the drive modules 500 may include a plurality of wheels 510. The drive module 500 may also include ports (e.g., connection ports) 525 and 527, which may be identical or similar to each other. At least one of the connection ports (e.g., 525) may be structured to communicate with the main body 300 via the suspension assembly 700 and receive power therefrom to power the motor 505, which may be an inrunner brushless steel motor. In example embodiments, each of the plurality of interchangeable drive modules may include the components described with reference to the example drive module 500.

The housing 502 of the drive module 500 may be metal, plastic, or another suitable material. In example embodiments, where separate portions of the housing 502 interface (e.g., connect), the drive module 500 may include redundant sealing. For example, redundant sealing may include two seals (e.g., seal caps) at each interface of the housing 502, at least where practical. In some embodiments, redundant sealing may be included at least around external electrical connections such as at ports 525 and 527.

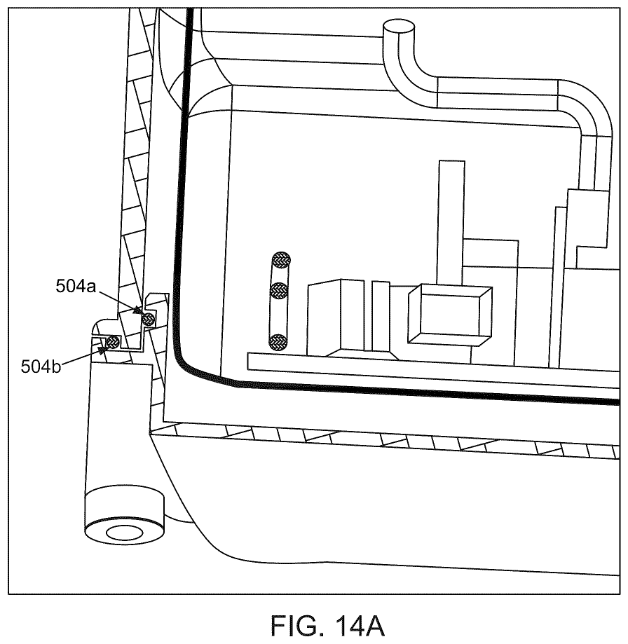

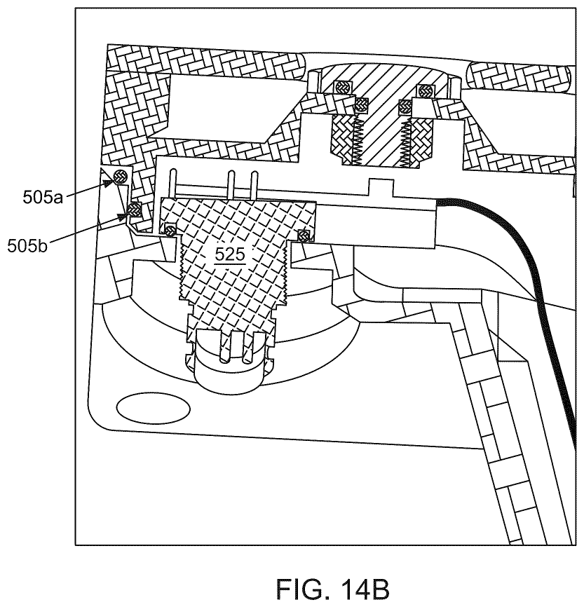

FIGS. 14A-14B illustrate an example embodiment of a drive module 500 with redundant sealing. For example, with reference to FIG. 14A, the drive module includes two seals 504a, 504b at a first interface between different portions of the housing 502, and with reference to FIG. 14B, two seals 505a, 505b at a second interface between different portions of the housing 502 (including around port 525). Redundant sealing in accordance with example embodiments may improve the prevention of water ingress into the drive module 500, including from couplant fluid (e.g., water) during an inspection operation. Additionally, redundant sealing may provide more forgiveness in assembly variability.

In example embodiments described herein, a PCB that includes its associated components (e.g., as attached thereon or therein) may be referred to as a printed circuit board assembly (PCBA), although the terms PCB and PCBA may be used interchangeably. For example, in example embodiments, a controller PCB of the drive module 500 may include (e.g., thereon) a controller for the motor 505, and may be referred to herein as a controller PCBA 530. The controller PCBA 530 (or another PCBA) may also include a non-transitory computer readable storage medium, separate from or integrated with the controller, which may store instructions for the controller. The controller may connect to port 525 via flexible PCBA 520, through which the controller may communicate (e.g., electrically) with the main body 300. Additionally, power may be provided (e.g., from the main body 300) to the drive module 500 via port 525. Thus, in some embodiments, the port 525 may include enough pins for both communication and power. Flexible PCBA 520 may provide reliability improvements over the use of crimped wire cables.

The main body 300 may include most controls for the motor 505, such as embodied in circuitry therein (e.g., on a drive module PCBA 336), so that the controller of the controller PCBA 530 may, in some examples, simply adjust the current to the motor 505 (e.g., a three-phase DC current) under the control of the main body 300. This may simplify the controller PCBA 530, making it less prone to faults in manufacturing and during operation. In some embodiments, the circuitry of the main body 300 may be configured to control the inrunner brushless steel motor 505 of each drive module of the plurality of interchangeable drive modules, including controlling the current to power the inrunner brushless steel motors 505. For example, the main body 300 may directly control the current flowing to the drive module 500, or the main body 300 may control the current by instructing the controller of the controller PCBA 530 accordingly.

Furthermore, in some embodiments, each of the plurality of interchangeable drive modules—which, for example, may each correspond to a drive module 500 (e.g., more specifically, the controller of the drive module 500)—may identify its position as the first, second, third, or fourth drive module (e.g., a front right, rear right, front left, or rear left drive module) to the circuitry of the main body 300 after being connected to the main body 300, for example via at least one of the plurality of connection ports (e.g., port 525). As an example, in practice, each of the plurality of interchangeable drive modules may identify its position to the main body 300 based on a location of a connection of the respective drive module to the suspension assembly 700. For example, with reference to FIG. 9, drive module 420 may “identify” its position as the front right drive module to the circuitry of the main body 300 by virtue of its connection to a port on the suspension assembly 700 corresponding to a drive module located in the front right position (“right” being relative to a top view of the inspection robot 110 and in a direction of travel 110D of the inspection robot 110). Likewise, drive module 460 may identify its position as the front left drive module, drive module 440 may identify its position as the rear right drive module, and drive module 480 may identify its position as the rear left drive module. With knowledge of each interchangeable drive module's position, the circuitry of the main body 300 (e.g., a drive module PCBA 336) may control the plurality of interchangeable drive modules (e.g., the current that powers their motors) according to their respective identified positions and a desired movement of the inspection robot 110.

For example, in some embodiments, the main body 300 may inform the drive module 500 of its position as the first, second, third, or fourth drive module after the drive module 500 is connected to the main body 300. Thus, in some embodiments, a drive module 500 may be interchangeable between any of the four positions.

The drive module 500 may also include a port 527 (e.g., at least one drive module connection port), which in some embodiments may be identical or similar in structure to port 525. Meanwhile, as illustrated in FIG. 13, at least one encoder assembly 600 may include at least one encoder assembly connection port 627. In some embodiments, at least one drive module 500 and at least one encoder assembly 600 may communicate via the least one drive module connection port 527 and the at least one encoder assembly connection port 627. For example, for drive modules 500 that are provided at the rear of the inspection robot 110 (e.g., second drive module 440 and fourth drive module 480 in FIG. 9), the port 527 may connect (e.g., electrically) to an encoder assembly 600 as described herein, and receive data from the encoder 600 therefrom. In some embodiments, the drive module 500 may pass data from the encoder 600 to the main body 300 via PCBA 530, flexible PCBA 520, and/or port 525.

As described above, the PCBA 530 may control current flow to motor 505 to power the motor 505. In some embodiments, motor 505 may be an inrunner brushless motor. For example, motor 505 may be an inrunner brushless steel motor, which may be operatively connected to the gear assembly 515. In such an example, the steel casing of the motor 505, as may be included in each of the interchangeable drive modules of the inspection robot 110, may shield the motor from magnetic forces, including electromagnetic forces and interference generated by the operation of the inspection robot 110 and/or the magnetic forces of wheels 510. Thus, reliability may be improved. In some embodiments, each drive module 500 may include one motor 505, although embodiments are not limited thereto. For example, in some embodiments, one motor 505 may be structured to drive the wheels of two or more drive modules 500.

In example embodiments, each drive module 500 may include one wheel 510, although embodiments are not limited thereto. For example, in some embodiments, some or all of the drive modules 500 may each include two or more wheels 510 for greater adhesion to a ferromagnetic inspection surface. Alternatively or additionally, in embodiments where greater adhesion may be desired, the inspection robot 110 may include a magnetic adhesion patch on its underside. As noted above, the wheel 510 may be magnetic, and the combined magnetic force of some or all wheels of the inspection robot 110 (e.g., in some embodiments, wheels of drive modules 420, 440, 460, and 480) may be sufficient to adhere the inspection robot 110 to a ferromagnetic inspection surface 101.

The wheel 510 may be structured to envelope or otherwise accommodate the gear assembly 515. For example, an inner diameter of the wheel 510 may be large enough to accommodate the gear assembly 515. Thus, an overall width of the drive module 500 may be less than if the gear assembly 515, motor 505, and wheel 510 were axially displaced from each other. In some embodiments, the gear assembly 515 may be a flex wave gear motor assembly.

In some embodiments, the inspection robot 110 may include at least one encoder assembly 600 attached to at least one drive module, and the at least one drive module may be structured to support (e.g., physically and/or through electrical communication) the encoder assembly 600. For example, with reference to FIG. 9, in example embodiments, one or each rear drive module, including second drive module 440 and fourth drive module 480, may be attached to respective encoders (e.g., encoder assemblies) 620 and 640. Furthermore, with reference to FIG. 12C, one or each rear drive module may include a passive gas spring 660, which may bias the respective encoders 620 and 640 against the inspection surface according to a desired amount of force. The use of passive gas springs in example embodiments may provide reliability advantages over an active linear actuator. Additionally, the use of a gas spring over a physical spring with a spring constant may provide a more linear force profile as the inspection robot 110 traverses an inspection surface 101 with angular surface transitions thereto.

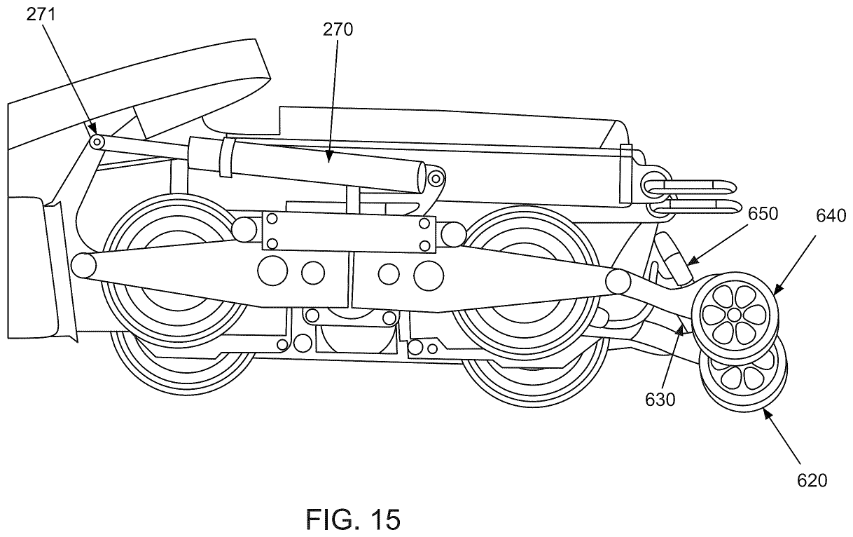

In some embodiments, at least one encoder assembly 600 may include a passive device to bias the wheel 608 of the at least one encoder assembly 600 against the inspection surface 101. The passive device may include at least one passive gas spring and the passive gas spring may be attached to the at least one drive module. For example, with reference to FIG. 15, encoders 620 and 640 may respectively include passive gas springs 630 and 650, which may, together with or independently of any passive gas springs 660, bias the encoders 620 and 640 against the inspection surface with a desired amount of force, and which may be attached to respective drive modules 480 and 440. The passive gas springs as described herein may either individually or collectively provide sufficient downforce for the encoders 620 and 640 to maintain traction while also remaining elastic enough that as the inspection robot 110 traverses the inspection surface, the encoders 620 and 640 may remain in contact but accommodate angular surface transitions. The two encoders 620, 640 may allow for confirmation of the encoder information (e.g., determining that one encoder is slipping and/or has raised from the surface, allowing the determination of distance information from the other encoder).

Additionally, the at least one encoder assembly 600 may be structured to support the inspection robot 110, such as against a liftoff tendency of the inspection robot 110. For example, the gas springs as described herein may provide for the encoders 620 and 640 to function as secondary stability support devices for the inspection robot 110—for example, in the event that the wheels 510 of the drive modules lose adhesion. For example, the encoders 620, 640 may resist the rotation of the inspection robot 110 away from the surface 101 if the wheels of the front drive modules of the inspection robot 110 lose contact with the surface 101, and/or if they encounter a portion of the surface 101 where the magnetic contact force is lost or degraded.

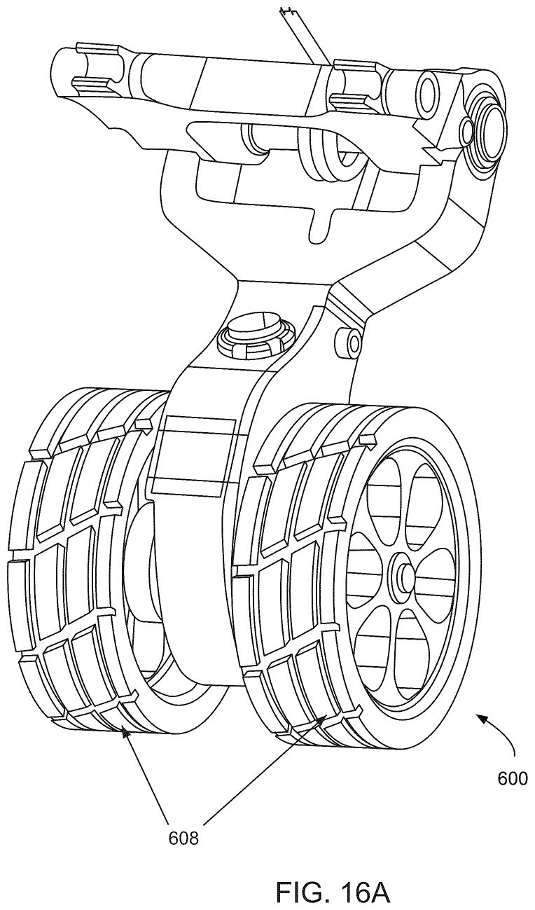

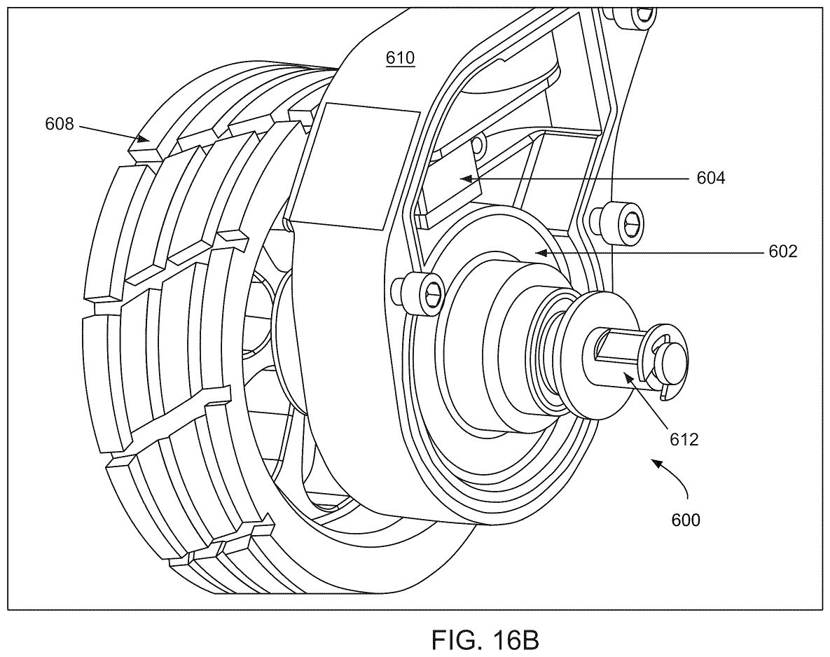

In example embodiments, the internal structure of each encoder 620 and 640 may be identical and/or may be represented by encoder 600 of FIGS. 16A-16B. FIG. 16A illustrates an encoder 600 (also referred to as an encoder assembly) with both wheels 608 according to an example embodiment, and FIG. 16B illustrates internal components of an encoder 600 with one wheel 608 removed according to an example embodiment. Examples are not limited thereto, and in some embodiments, the encoder assembly 600 may include one wheel 608, while in other embodiments, the encoder assembly may include a plurality of wheels 608, such as two wheels 608, as illustrated in FIG. 16A. Encoder 600 may be a hall effect encoder. Encoder 600 may be a radial encoder and may include, within an enclosure 610, a ring 602 and a read head (e.g., a radial read head) 604. Encoder 600 may also include an axial shaft 612 connecting between the wheel(s) 608 and the enclosure 610 to transfer rotational movement from the wheel(s) 608 to the ring 602 for reading by the radial read head 604. Ring 602 and wheel 608 may both turn on a common axial shaft 612.

Thus, as wheel 608 turns against the inspection surface 101, rotational movement is transferred thereto and the magnetic ring 602 may rotate accordingly, while the radial read head 604 may scan the outer circumference of the ring 602. For example, in some embodiments, the radial read head 604 may scan magnetic patterns on the ring 602 as the ring 602 rotates. The use of a radial encoder with a radial read head 604 scanning the outer circumference of the ring 602, versus other types of encoders such as an axial ring encoder, which may scan a side of the ring 602, may improve the compact structure of the internal components of encoder 600, at least in a widthwise (e.g., horizontal) direction.

With reference to FIG. 9, the inspection robot 110 of inspection robot system 100 may include a suspension assembly 700. Suspension assembly 700 may connect to drive modules 420 and 440 such that it is fixed to drive modules 420 and 440 on a second side (which may also be referred to as a second end 2E), and connect to drive modules 460 and 480 such that it is fixed to drive modules 460 and 480 on a first side (which may also be referred to as a first end 1E). For example, suspension assembly 700 may be connected by bolts 421 (as shown in FIG. 11—or any other fastener, such as a rivet or machine screw) to drive modules 420 and 440 to be affixed to both drive modules thereto, and suspension assembly 700 may be connected by bolts 421 (or any other fastener) to drive modules 460 and 480 to be affixed to both drive modules thereto. Furthermore, suspension assembly 700 may connect to main body 300 with bolts 705.

In an example, a first end drive module (e.g., the third drive module 460) of the plurality of interchangeable drive modules may be attached to the first end 1E of the suspension assembly 700 and to the payload 200 (e.g., as described by example elsewhere herein), and a second end drive module of the plurality of interchangeable drive modules (e.g., first drive module 420) may be attached to the second end 2E of the suspension assembly 700 and to the payload 200. As described and illustrated herein, the second end 2E may be opposite to the first end 1E of the suspension assembly 700—for example, in a widthwise or horizontal direction relative to a direction of travel 110D of the inspection robot 110 on the inspection surface 101, and/or relative to the main body 300.

In some embodiments, at least one drive module (e.g., drive modules 420 and 460) may therefore be attached to the suspension assembly 700 and may also be attached to the at least one payload 200 (e.g., via a support rail 210 and clamping devices 424 and 464 as described by example herein). Thus, in examples, the payload 200 may be attached to the main body 300 via at least one drive module, such as drive modules 420 and 460.

In some embodiments, with reference to FIG. 9, the at least one drive module may include a first end drive module (e.g., fourth drive module 480), which may be interchangeable, and which may be attached to a first side (or first end 1E) of the suspension assembly 700, and a second end drive module (e.g., second drive module 440), which may be interchangeable, and which may be attached to a second side (or second end 2E) of the suspension assembly 700.

Additionally, the at least one encoder assembly 600 may include a first encoder assembly 640 attached to the first end drive module 480 and a second encoder assembly 620 attached to the second end drive module 440. In some embodiments, as illustrated in FIG. 9, the at least one drive module may include four drive modules, and the first end and second end drive modules 480 and 440 may be rearward of the other two of the four drive modules 460 and 420 relative to a travel direction 110D of the inspection robot 110. The axial shaft 612 of the first encoder assembly 640 may transfer rotational movement (e.g., from wheel(s) 608) to the ring 602 of the first encoder assembly 640, and the axial shaft 612 of the second encoder assembly 620 may transfer rotational movement (e.g., from wheel(s) 608) to the ring 602 of the second encoder assembly 620.

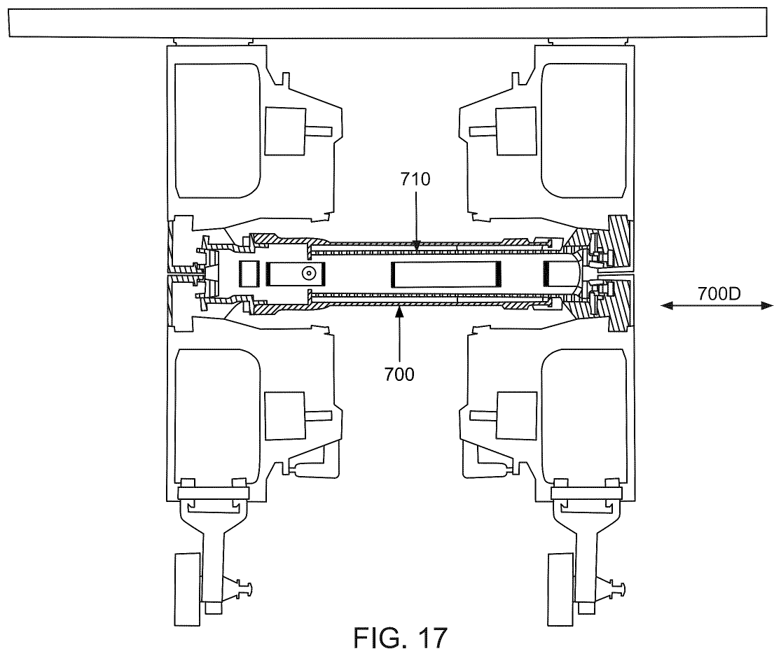

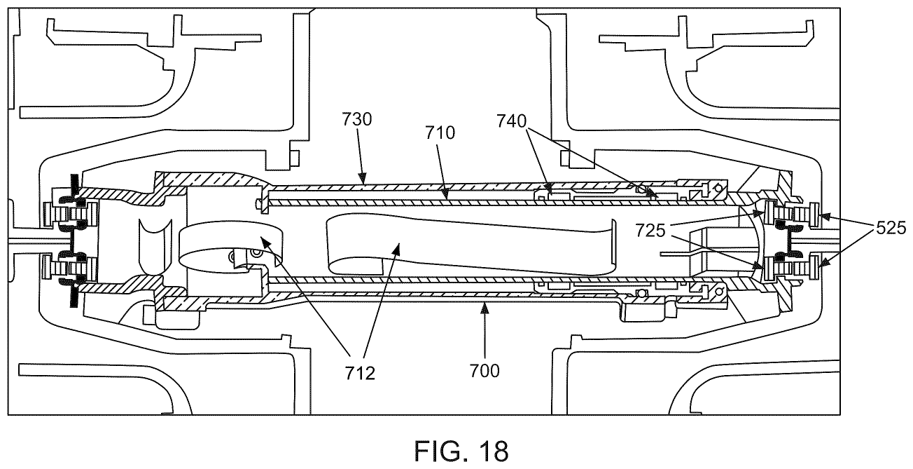

Meanwhile, through expansion and contraction of a center tubular member or section 710 (see FIGS. 17-18), which may be metal, in the directions indicated by arrow 700D (e.g., a widthwise or horizontal direction relative to a travel direction 110D of the inspection robot 110), the drive modules 420 and 440 (e.g., on a “right” or second side of the inspection robot 110) may change position relative to other portions of the inspection robot 110, including the main body 300, the drive modules 460 and 480, and the payload 200 (although drive module 420 may slide along the support rail 210 of payload 200 and remain attached thereto). Thus, the expansion and contraction of the center tubular section 710 of suspension assembly 700 may cause the second side drive modules 420 and 440 and first side drive modules 460 and 480 to be asymmetrical relative to the inspection robot 110 and, more particularly, the main body 300, such as relative to a center line CL of the main body as shown in FIG. 1. Thus, the distance (spacing) between the second side drive modules 420 and 440 (including their wheels making contact with the inspection surface) and first side drive modules 460 and 480 (including their wheels making contact with the inspection surface) may be adjusted as desired, such as based on features of the inspection surface. For example, the spacing may be adjusted based on a quantization of boiler pipe tubes to be inspected such that the wheels of the respective drive modules each make contact with the tops of the tubes as the inspection robot 110 traverses the inspection surface 101. In some examples, when the suspension assembly 700 expands or contracts, the at least one second end (or side) drive module(s) (e.g., 420 and 440) move relative to the main body 300, and the at least one first end (or side) drive module(s) (e.g., 460 and 480) remain fixed relative to the main body 300. Thus, the at least one second end drive module may have a position relative to the at least one first end drive module and the payload 200 that is adjustable by extraction or retraction of the suspension assembly 700.

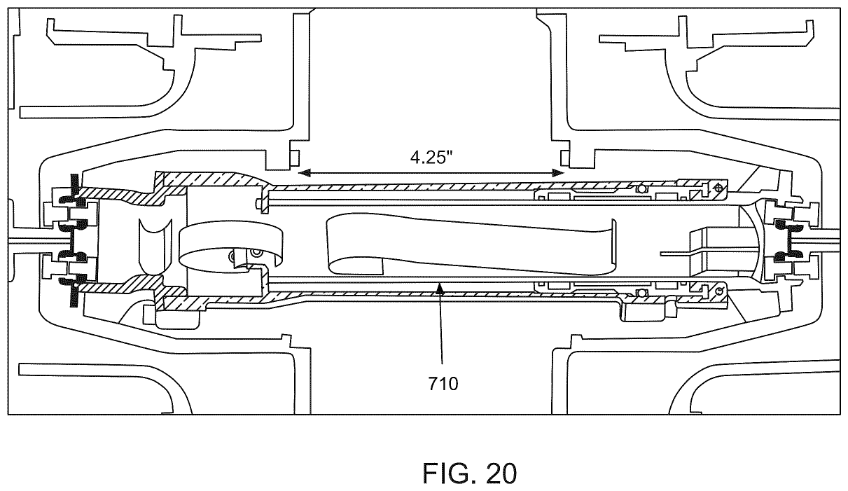

In one example, the center tubular section 710 may have a 4.25 inch stroke (see, e.g., FIG. 20) and therefore provide for 4.25 inches of movement. Thus, the spacing of the wheels of the drive modules may be adjustable by over four inches. For example, the wheels of the drive modules may have an adjustable spacing of a range greater than or equal to between 12 inches to 15 inches. For an inspection surface 101 including pipes with outer diameters of 4 inches, the spacing of the wheels may be selected to be 12 inches. Meanwhile, for an inspection surface 101 including the shell of a tank, the spacing may be differently selected based on the contours of the surface 101.

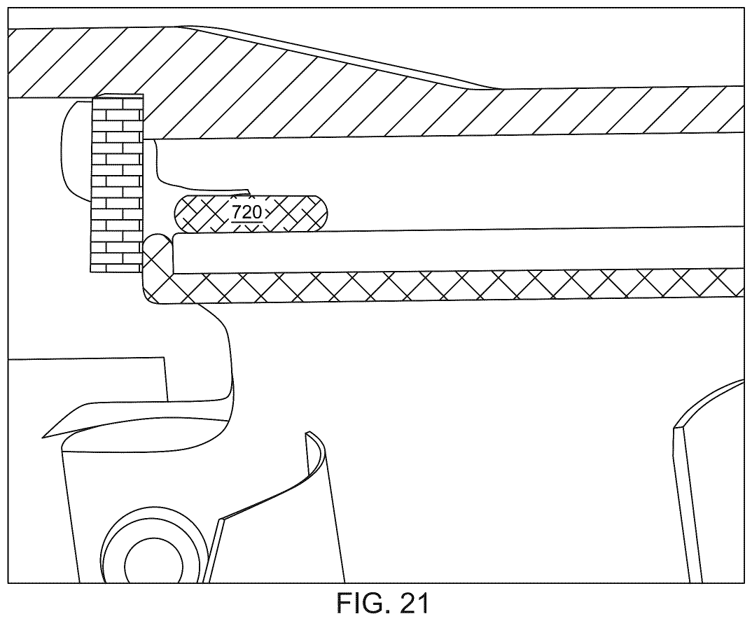

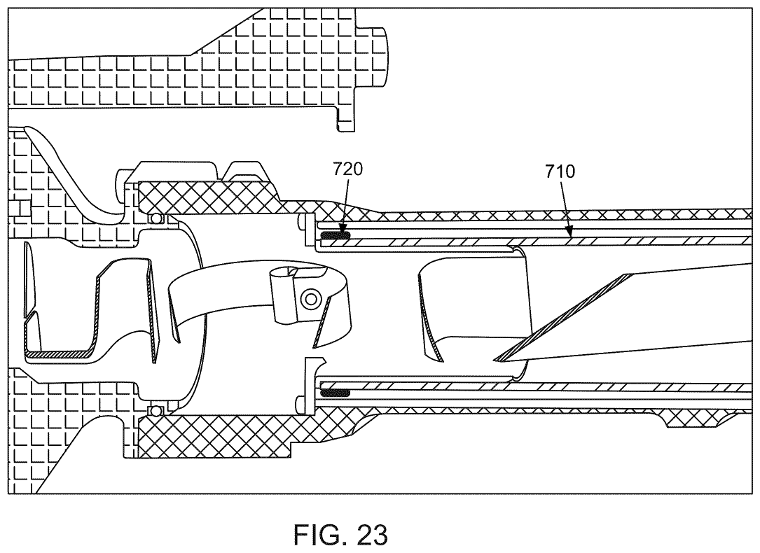

In an example embodiment, the center tubular section 710 is made of metal, such as titanium. An outer tubular member or section 730, which may also be made of a metal such as a titanium, aluminum, or steel, may remain static with the rest of the inspection robot 110 as the center tubular section 710 expands or contracts. With reference to FIGS. 21 and 23, a stop 720 may prevent further inward movement of the inner tubular section 710 and provide an inner limit to the stroke length of center tubular section 710. In some embodiments, a user may adjust the length of the projection of center tubular section 710 by manually unfixing the center tubular section 710 from its position (e.g., by loosening screws or bolts), pulling out or pushing in the center tubular section 710 relative to the outer tubular section 730, and manually refixing the center tubular section 710 at its new position. However, embodiments are not limited thereto, and in some embodiments, a linear actuator or other automated mechanism may adjust the inner tubular section 710. Additionally and/or alternatively, in some embodiments, the front drive module(s) may include a clamping device 424 such as clamping mechanism to attach to the support rail 210 of the payload 200. The clamping device may be structured to be loosened to adjust the distance between the first end drive module(s) and the second end drive module(s). For example, clamping mechanism 424 of drive module 420 (which, in FIG. 9, may correspond to a front, second end drive module) may be loosened to allow the drive module 420 to shift along the support rail 210 to thereby adjust its (and drive module 440's) distance from drive modules 460 and 480, then tightened. Or, in some embodiments, the clamping mechanism 424 may remain loose and/or be absent, and the drive module 420 may rely on a fixing of position provided by the center tubular section 710 of suspension assembly 700 for maintaining a selected distance. Thus, in some embodiments, a center section (e.g., center tubular section 710) of the suspension assembly 700 may expand and contract to adjust a selectable distance between the at least one first end drive module(s) (e.g., drive modules 460 and 480) and the at least one second end drive module(s) (e.g., drive modules 420 and 440). In some embodiments, this selectable distance may be in a widthwise direction relative to a direction of travel of the inspection robot 110 on the inspection surface 101.

By moving the right side drive modules 420 and 440 relative to the rest of inspection robot 110, the main body 300 and associated wires/cables may remain largely static, improving reliability, while adjusting the spacing between wheels 510 (e.g., via the selectable distance) to accommodate different inspection surfaces. At least one electrical connection 712, which may include wires/cables and/or flexible PCBs (which may replace some wires/cables), may be enclosed within the suspension assembly 700 and may provide communication between the right side drive modules and the main body 300 and provide power to the right side drive modules. Additionally, the at least one electrical connection (e.g., wires/cables and/or flexible PCBs) 712 may provide communication and power to the left side drive modules. In example embodiments, the at least one electrical connection 712 may be within the center tubular section 710 (which may also be referred to herein as a tubular metal member) and structured to communicate between the plurality of drive modules and a main body 300 of the inspection robot 110. In some embodiments, the at least one electrical connection 712 may include a flexible electrical connection. The flexible electrical connection may include at least one of a flexible cable, a wiring, or a flexible printed circuit board (PCB).

In some embodiments, each of the plurality of interchangeable drive modules (e.g., 420, 440, 460, 480) may include a connection port 525 structured to connect to a connection port 725 of the suspension assembly 700 and receive power and control therefrom. By examples described herein, the suspension assembly 700 may be structured to provide electrical connections between the main body and the plurality of drive modules, and each of the plurality of interchangeable drive modules may receive the power and the control from the main body 300 via the suspension assembly 700. The power may, among other things, power the inrunner brushless steel motor 505 of each of the drive modules.

For example, with reference to FIG. 18, ports 725 of the suspension assembly 700, which may be electrically connected to the at least one electrical connection 712 (e.g., wires/cables and/or flexible PCBs), may be structured to connect to ports (e.g., connection ports) 525 of the right side drive modules and transmit communication and power thereto. Likewise, in some embodiments, the at least one electrical connection 712 (e.g., the wires/cables and/or flexible PCBs) may similarly connect to the left side drive modules 460 and 480 via ports 725 and ports (e.g., connection ports) 525 of the left side drive modules. However, embodiments are not limited thereto, and in some embodiments, power and/or communication may additionally and/or alternatively be provided to the left side drive modules by external wires/cables, since (unlike the right side drive modules) the left side drive modules may be fixed in position relative to main body 300.

It should be noted that while example embodiments describe the first end 1E (e.g., left side) drive modules fixed in position relative to the main body 300 and/or payload 200, and the second end 2E (e.g., right side) drive modules adjustable in position by expansion or contraction of the suspension assembly 700, this description is for example only and embodiments are not limited thereto. For example, in some embodiments, it may be the second end 2E (e.g., right side) drive modules that are fixed in position, and the first end 1E (e.g. left side) drive modules may be adjustable in position by expansion or contraction of the suspension assembly 700. This may be achieved, for example, by the suspension assembly attaching to the main body 300 at the second end 2E of the suspension assembly 700 rather than the first end 1E.

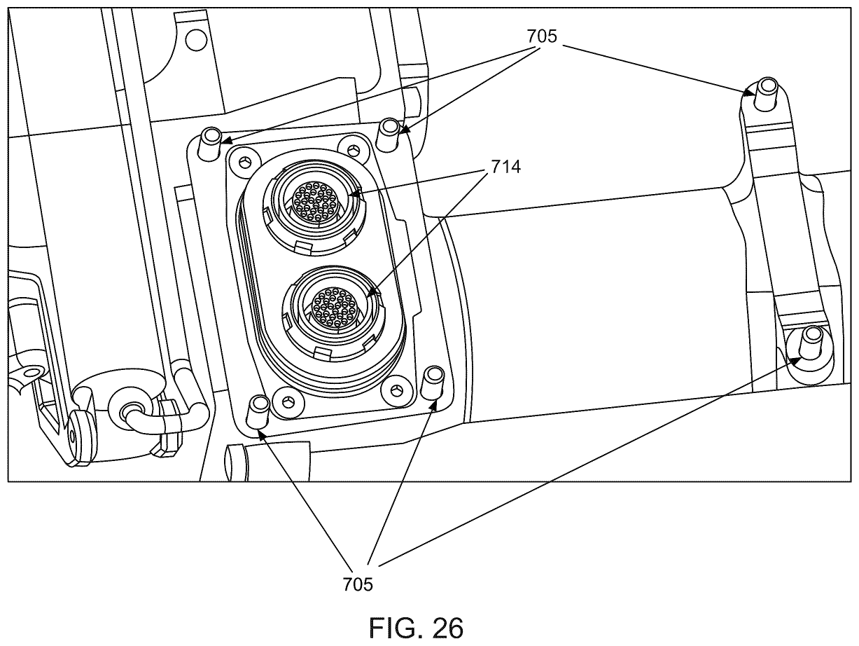

With reference to FIG. 26, the suspension assembly 700 may include a plurality of main body connection ports 714 to electrically connect to the main body 300, and the plurality of drive module connection ports 725 as described herein to electrically connect to each of the plurality of drive modules. All or some power and electrical communications may be provided between the drive modules and the underside of the main body 300 via these main body connection ports 714 of the suspension assembly 700, which may connect to the at least one electrical connection 712 (e.g., wires/cables and/or flexible PCBs) that run to the drive module connection ports 725. Thus, the suspension assembly 700 may provide power and electrical communications from the plurality of main body connection ports 714 to the plurality of drive module connection ports 725.

In an example embodiment, the suspension assembly 700 may be attached to the main body 300 at a first end 1E of the suspension assembly 700 (which in the figures may, for example, correspond to the left side of the suspension assembly 700 from a top view of the inspection robot 110), and these connection ports 714 may be at the first end 1E of the suspension assembly 700. For example, the power and communications to the right side drive modules may connect via one of the connection ports 714, and the power and communications to the left side drive modules may connect to the other of the connection ports 714. Thus, these connection ports 714 may define the “handedness” of the drive modules. For example, a handedness of each of the plurality of drive modules may be defined by its connection to at least one of the plurality of drive module connection ports 725, which in turn is provided with power and communications from either one or the other main body connection ports 714 depending on the side of the inspection robot/suspension assembly 700 that it is on. As an example, the main body 300 (e.g., circuitry therein) may determine that the at least one first end drive modules are on a left side of the suspension assembly and determine that the at least one second end drive modules are on a right side of the suspension assembly based on the drive module connection ports 725 to which the first end and second end drive modules are connected. This connection-based detection of the handedness of each of the drive modules may allow for each of the drive modules to be identical and replaceable without a need for custom configuration of the drive module.

FIG. 47 illustrates an example method 1200 of replacing a first, to-be-replaced drive module (which may be any of the interchangeable drive modules described with reference to example embodiments herein, such as drive module 420, 440, 460, or 480) of an inspection robot 110 including a payload 200 and a suspension assembly 700 according to example embodiments. The method 1200 may include loosening 1205 a clamping device 424 of the first drive module to detach the first drive module from a support rail 210 of the payload 200. The payload 200 may include a plurality of ultrasonic (UT) sensors 240. Further, the method 1200 may include removing 1210 a plurality of bolts 421 attaching the first drive module to the suspension assembly 700, and removing 1220 the first drive module from the inspection robot 110, including disconnecting the first drive module from a connection port of the suspension assembly 700. In some examples, the method 1200 may include removing 1215 an outer plate 422 prior to the removing the first drive module from the inspection robot 110.

The method 1200 may further include attaching 1225 a second, replacing drive module to the inspection robot 110, including connecting the second drive module to the connection port of the suspension assembly 700 (e.g., the same connection port to which the first, to-be-replaced drive module was connected). The second drive module may include a core that is identical to a core of the first drive module. For example, both drive modules may have identical internal components. As may be described elsewhere herein, in some embodiments, the cores of each of the first and second drive modules may include identical redundant sealing, gear assemblies, magnetic wheels to accommodate the gear assemblies, and inrunner brushless steel motors operatively connected to the gear assemblies. The method 1200 may also include adding 1230 the plurality of bolts 421 to attach the second drive module to the suspension assembly 700. The method may additionally include tightening 1235 a clamping device of the second drive module to attach the second drive module to the support rail of the payload.

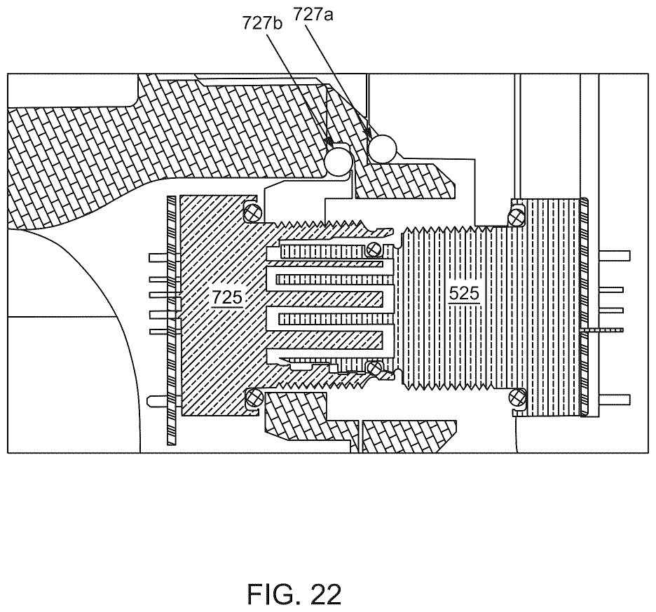

In example embodiments, with reference to FIG. 22, which is an example close-up cross-section view of port 725 connected to port 525, the suspension assembly 700 may include redundant sealing (e.g., two or more seals 727a, 727b) at the interfaces around port 725. Furthermore, the ports 725 and 525 may include a liquid resistance rating, such as an IP rating.

With reference to FIG. 1, in some embodiments, the suspension assembly 700 may be structured to provide for a limited angle of rotation RSR about a center axis 700A of the center tubular section 710 (e.g., running through the center of the tubular portion of suspension assembly 700) by the right side drive modules 420 and 440 (e.g., the second end drive modules) such that they may rock back and forth as the inspection robot 110 traverses an obstacle or an uneven inspection surface. Likewise, the suspension assembly 700 may be structured to provide for a limited angle of rotation LSR about the center axis 700A by the left side drive modules 460 and 480 (e.g., the first end drive modules) such that they may rock back and forth as the inspection robot traverses an obstacle or an uneven inspection surface. In some embodiments, the center axis 700A and the directions of expansion/contraction indicated by arrow 700D may be parallel.

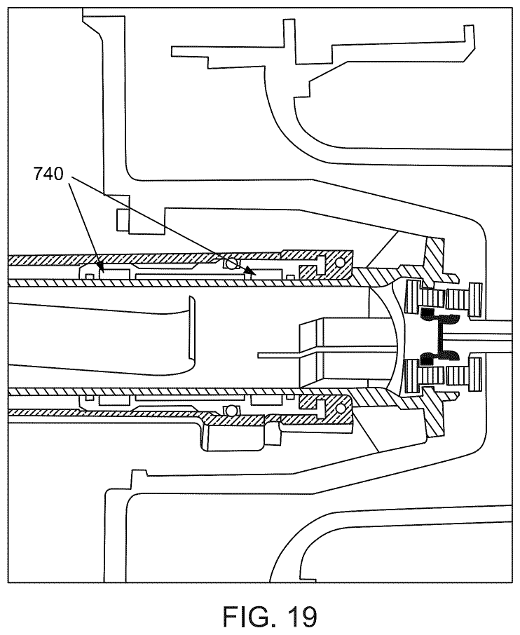

With reference to FIG. 18-19, in example embodiments, the suspension assembly 700 may include one or more wear rings 740 to maintain contact with the center tubular section 710 as it remains in a fixed position, expands, or contracts (e.g., “telescopes”) to a selectable position and thereby provides the selectable distance between the first end drive modules on the first end 1E and the second end drive modules on the second end 2E. In some embodiments, there may be at least two wear rings 740. In some embodiments, the wear ring 740 may be fixed relative to movement of center tubular section 710. For example, the wear ring 740 may be fixed in or to the outer tubular section 730 to maintain contact with the center tubular section 710 as it telescopes relative to the outer tubular section 730.

With reference to FIG. 2, in example embodiments, biasing devices 270 and 275 may be disposed on the left and right sides of inspection robot 110. As shown in FIG. 15, biasing device 270 may connect to the payload 200 with a pivot connection 271, and likewise, biasing device 275 may also connect to the payload with a pivot connection. At the other end, the biasing devices 270 and 275 may respectively connect to the front or both drive modules on each respective side, and/or connect to the suspension assembly 700.

The biasing devices 270 and 275 may provide sufficient downforce for the sensor sleds 230 of payload 200 to maintain adequate contact with the inspection surface 101 for the sensors 240 to inspect the inspection surface 101.

In example embodiments, the biasing devices 270 and 275 may be passive devices. For example, the biasing devices 270 and 275 may be passive gas springs. Passive gas springs may have advantages over active devices as discussed by example elsewhere herein. However, embodiments are not limited thereto, and in some embodiments, the biasing devices 270 and 275 may be active devices such as linear actuators. The use of an active device such as a linear actuator may allow the inspection robot 110 to lift the payload including sensor sleds 230 off of the inspection surface when the inspection robot 110 is not inspecting the inspection surface.

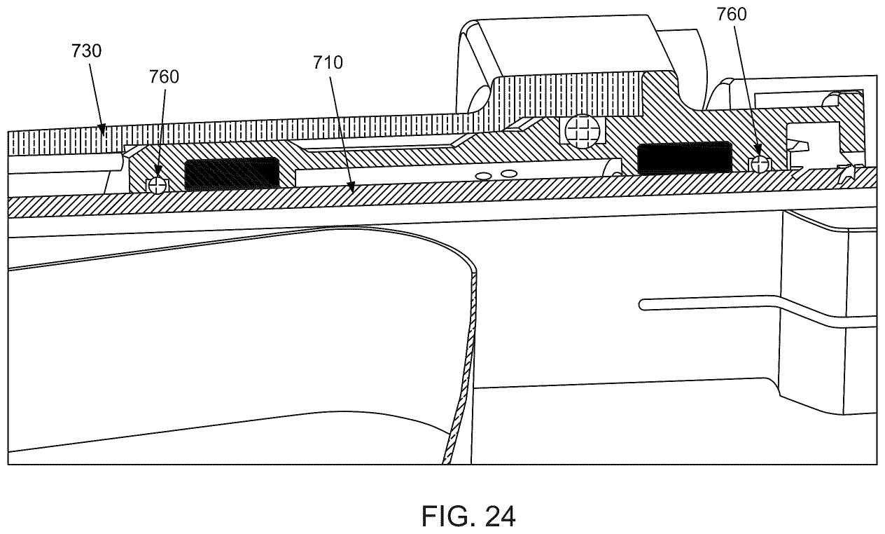

With reference to FIG. 24, in example embodiments, the suspension assembly 700 may include one or more o-rings 760 around the center tubular section 710. These o-rings 760, which may be referred to in example embodiments as EMI o-rings, may be structured to reduce electromagnetic interference (EMI) caused by the center tubular section 710. For example, in some embodiments, the center tubular section 710, which may be made of a metal such as titanium, may undesirably act as a radio antenna, such as for the signals it carries in the at least one electrical connection 712 (e.g., wires/cables and/or flexible PCBs) within. Therefore, the EMI o-rings 760 may help mitigate the EMI caused by the center tubular section 710. For example, the EMI o-rings 760 may break up or otherwise reduce the antenna effect of the center tubular section 710. In some embodiments, the EMI o-rings 760 may be fixed relative to movement of center tubular section 710. For example, the wear rings may be fixed in outer tubular section 730. In some embodiments, the EMI o-rings 760 may be a primary EMI mitigation strategy for the center tubular section 710. In an example, the EMI o-rings may include a polymer and/or synthetic rubber (e.g., silicone or fluorosilicone) with conductive material (e.g., a metal such as copper, silver, etc.) impregnated therein (e.g., chiefly on the surface) and/or uniformly distributed therein (e.g., doped), metal braiding, and/or metal coating. In an example, the EMI o-rings may include a silicone-based nickel-aluminum filled conductive elastomer. As there may be a plurality of o-rings 760 at one or more interfaces of the center tubular section 710, the o-rings 760 may also provide redundant sealing for the suspension assembly 700.

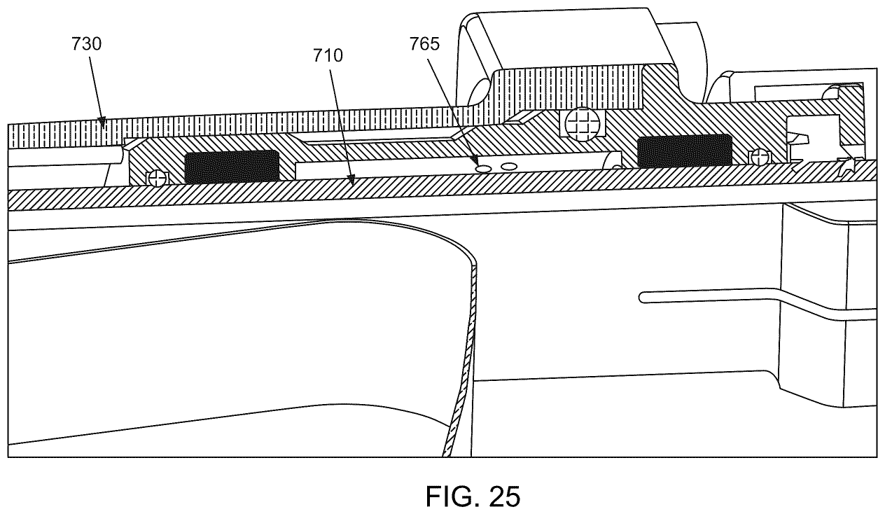

With reference to FIG. 25, in example embodiments, the suspension assembly may include one or more radial holes 765 (e.g., in the center tubular section 710) structured to accommodate one or more respective pogo pins to be inserted therein and provide an electrical connection between center tubular section 710 and outer tubular section 730. For example, the pogo pins may connect between the center tubular section 710 and the outer tubular section (e.g., outer metal member) 730. Such a structure may help mitigate the EMI caused by the center tubular section 710. In some embodiments, the radial holes 765 with pogo pins inserted therein may be a secondary EMI mitigation strategy for the center tubular section 710. For example, the radial holes and pogo pins may reduce the EMI emitted by the center tubular section 710.

With reference to FIG. 1, in example embodiments, the inspection robot 110 may include one or more handles. For example, as illustrated in FIG. 1, the inspection robot 110 may include a handle 750 on the right side (or second end) and a handle 755 on the left side (or first end). In some embodiments, the handles 750 and 755 may be fixed to the suspension assembly 700, the respective right side drive modules/left side drive modules, or both the suspension assembly 700 and the respective right side drive modules/left side drive modules. In an example, at least one handle 750 may be attached to at least one of the first and second drive modules 420 and 440 or the third and fourth drive modules 460 and 480.

FIG. 1 illustrates the handles 750 and 755 in a deployed or “down” position. In this position, the handles may provide for easy carrying or other maneuvering of the robot. For some use cases, the handles 750 and 755 may be deployed as a default or nominal position. In some embodiments, the handles 750 and 755 may improve the ergonomics of handling the inspection robot 110.

In example embodiments, the handles 750 and 755 may be moved from a deployed to a stowed or “up” position (and vice versa). For example, the inspection robot 110 may need to be packed or to traverse a narrow space, in which case it may be desirable to reduce the width of the inspection robot 110 by flipping up the handles 750 and 755.

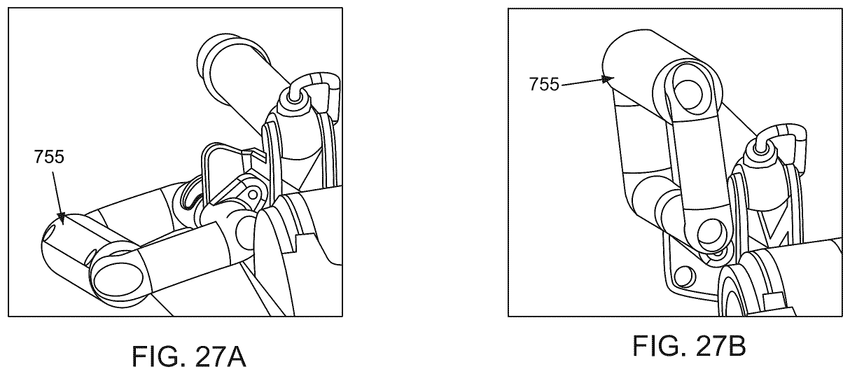

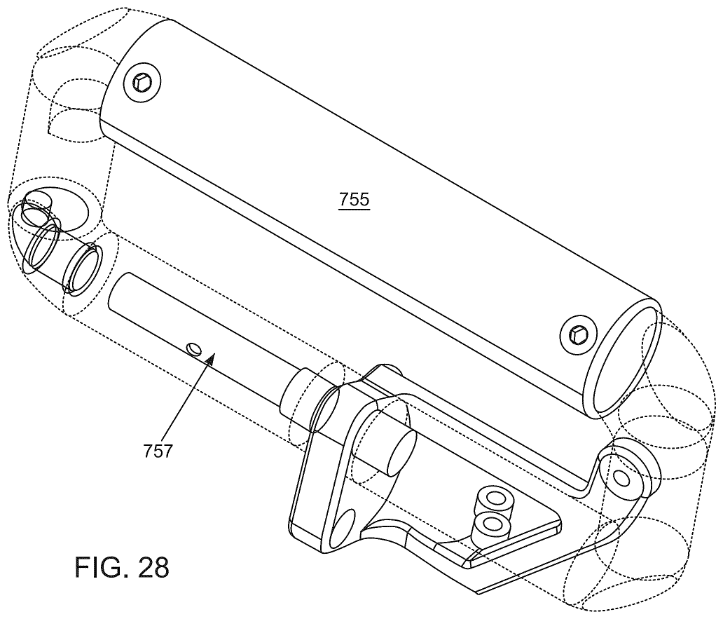

FIG. 27A shows an example of handle 755 in a deployed or down position, and FIG. 27B shows an example of handle 755 in a stowed or up position. With reference to handle 755 illustrated in FIG. 28 as an example, the handles 750 and 755 may each adjust between a deployed and a stowed position through a spring-loaded bolt locking mechanism 757.

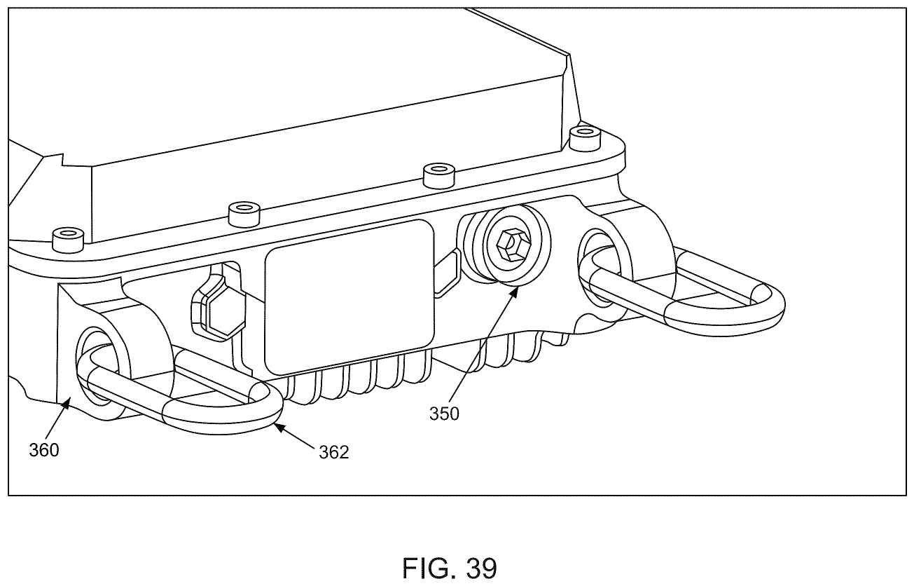

Additionally, with reference to FIG. 39, the inspection robot 110 may include one or more (e.g., two) grab hooks including rings 360 as part of (e.g., extensions from) main body 300 and associated brackets 362 therewith. Such grab hooks may be used, for example, to attach the inspection robot 110 to a safety line in case of a fall, and/or for use during service or hanging for storage. Such grab hooks may provide an operational convenience to the inspection robot 110.

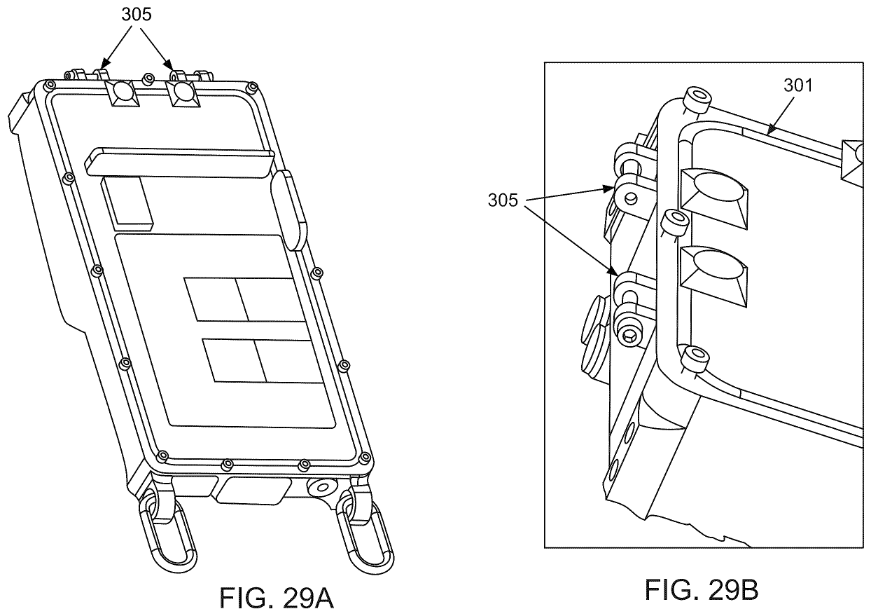

With reference to FIG. 3, in example embodiments, the main body 300 may include one (e.g., at least one) or a plurality of hinges 305 for opening and closing a lid 302 of the main body 300 (e.g., of the metal housing 307) and providing access therein. Thus, the lid 302 of the housing 307 may be structured to open and close via at least one hinge 305. FIGS. 29A and 29B show an example of main body 300 with lid 302 disconnected from a lower section 306 of the main body 300, with respective portions of hinges 305 illustrated.

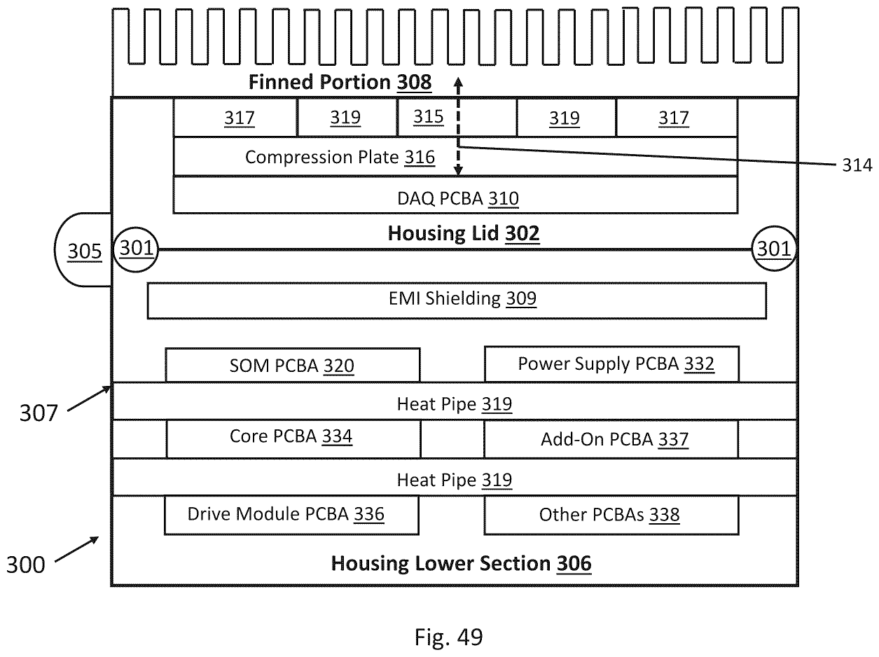

As shown in FIG. 29B and FIG. 49, in some embodiments, the main body 300 may include, within the metal housing 307, an electro-magnetic interference (EMI) sealing mechanism, which may include at least one EMI gasket for sealing and/or coupling the lid 302 to the lower section 306 of the housing 307. In an example, the at least one EMI gasket may include an EMI o-ring 301, which may provide both electrical and physical coupling between the lid 302 and lower section 306, reducing EMI interference from components internal to the main body 300 and reducing EMI interference to said components from outside the main body 300. In an example, the EMI o-ring 301 may include materials similar to and/or or the same as materials described for the EMI o-rings 760. For example, the EMI o-ring 301 may include a polymer and/or synthetic rubber (e.g., silicone or fluorosilicone) with conductive material (e.g., a metal such as copper, silver, etc.) impregnated therein (e.g., chiefly on the surface and/or uniformly distributed therein (e.g., doped), metal braiding, and/or metal coating. In an example, the EMI o-rings may include a silicone-based nickel-aluminum filled conductive elastomer. The EMI o-ring may enhance both thermal and electrical conductivity between the metal lid 302 and the metal lower section 306.

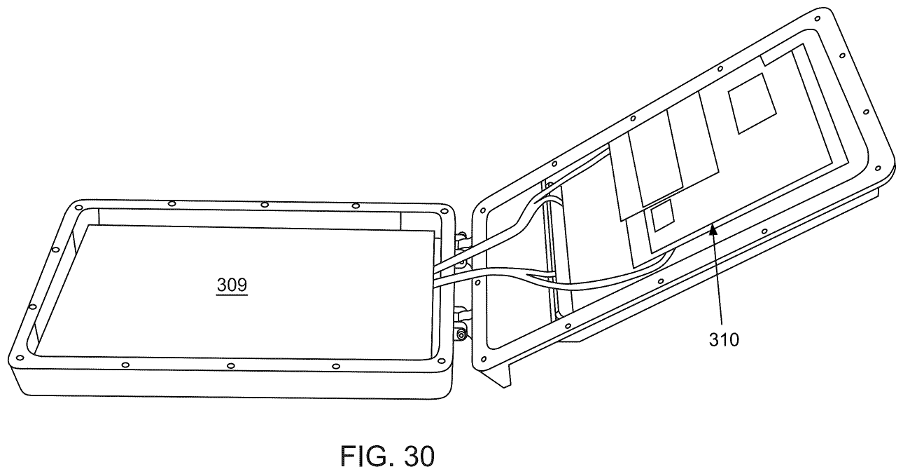

In example embodiments, the main body 300 may include, within housing 307, a plurality of PCBAs including a data acquisition circuit (DAQ) PCBA 310 and at least one other PCBA. A data acquisition circuit (DAQ) included on the DAQ PCBA 310, which may include an analog-to-digital converter (ADC), may be included in (e.g., located in) the lid 302 of the main body 300. FIGS. 30, 31, and 49 illustrate an example where the DAQ may be included on a DAQ PCBA 310 that is included in the lid 302. Meanwhile, as described for example embodiments herein, other electronic components such as other PCBAs may be provided in the lower section 306 of the main body 300.

In example embodiments, the DAQ may convert analog signals from the sensors 240, which may include UT sensors, to digital sensor signals. Thus, the main body 300 may provide digital sensor signals down a tether (e.g., via a tether interface 340 as described by example herein) to a base station. However, embodiments are not limited thereto, and in some embodiments, the main body 300 may provide analog sensor signals down the tether to the base station. Providing the DAQ in the main body 300 and converting the analog sensor signals to digital signals therein may have signal to noise (SNR) benefits and tether length benefits over sending analog sensor signals down the tether. Thus, the main body 300 may be able to receive and analyze more data from the sensors 240.

In some embodiments, the DAQ may have a fairly low temperature tolerance. Just as one example, the DAQ may have an upper temperature operating limit of 55-60 degrees C. In example embodiments, with reference to FIGS. 32 and 49, because passive cooling may not create a sufficient change in temperature (ΔT) to adequately cool the DAQ, the main body 300 may include at least one thermoelectric path 314 between the DAQ PCBA 310 and a finned portion 308 of the metal housing 307. The at least one thermoelectric path 314 may include at least one thermoelectric cooler (TEC) 315 (which may be an array of thermoelectric coolers 315) structured to wick away heat from the DAQ PCBA 310 to, e.g., a top 304 of the lid 302 of the metal housing 307, as described by example herein.

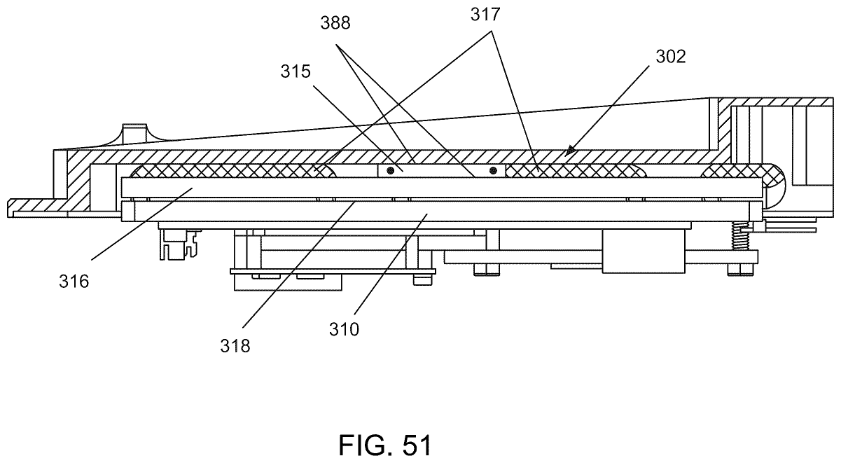

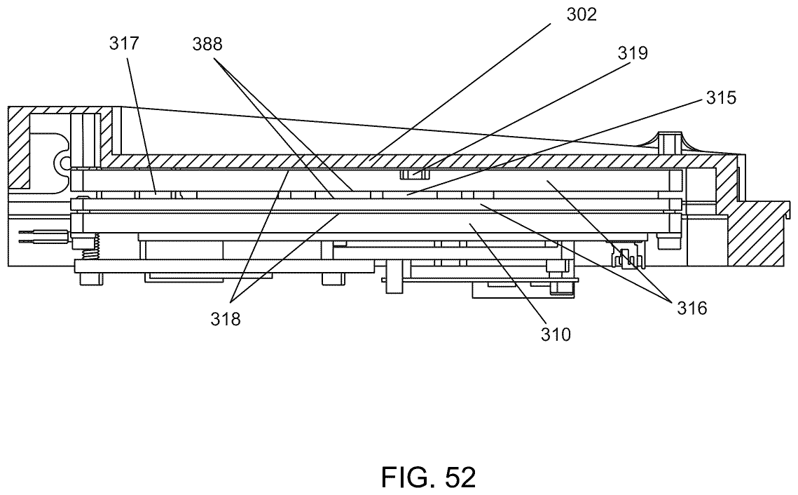

In example embodiments, the thermoelectric cooler(s) 315 may be an active cooling device and consume power (for example, a few watts and less than five amps). The thermoelectric cooler(s) 315 may be structured to boost a temperature differential between the DAQ PCBA 310 and the finned portion 308 of the metal housing 307 along the thermal path(s) 314. Additionally, with reference to FIGS. 51-52 (which illustrate example embodiments providing a thermal path 314 in a lid 302 of an inspection robot 110), thermal paste and/or grease 388 may be included between components where thermal conduction is desired, such as between the DAQ PCBA 310, the thermoelectric cooler(s) 315, and one or more compression plates 316.

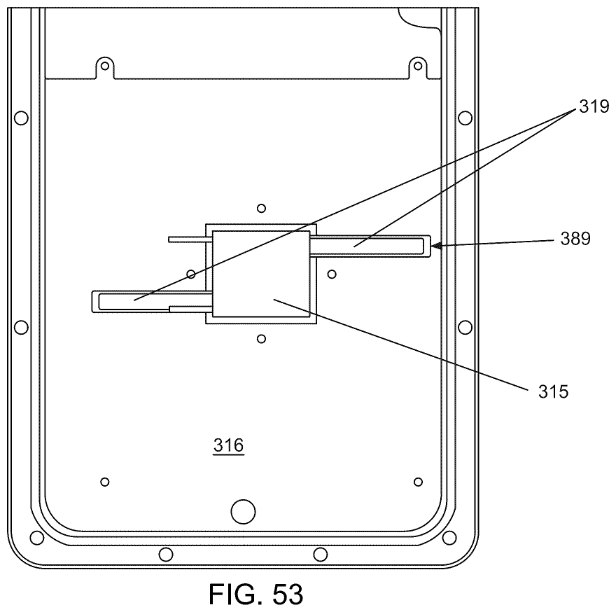

For example, with reference to FIGS. 32, 49, and 51-53, the main body 300 may include one or more compression plates 316. In some embodiments, at least one compression plate 316 may be a part of the thermal path 314 and be structured to be between lid 302 of the metal housing 307, the thermoelectric cooler(s) 315, and at least one or a plurality of passive heat pipes 319 on one side, and the DAQ PCBA 310 on the other side, to thereby provide thermal conductivity from the thermoelectric cooler(s) 315 to the lid 302 and to wick heat from the DAQ PCBA 310 to the metal housing 307. Thus, in some examples, the at least one thermoelectric cooler 315 may be between the lid 302 and at least one compression plate 316 (see, e.g., FIGS. 51 and 52). Furthermore, in some examples, another compression plate 316 may be between the at least one thermoelectric cooler 315 and the lid 302 (see, e.g., FIG. 52).

For example, as illustrated in FIGS. 51-52, one or a plurality of compression plates 316 may be between the lid 302, thermoelectric cooler(s) 315, and DAQ PCBA 310 to help provide the thermally conductive paths 314 therethrough. Thermally insulative fasteners and washers (e.g., made of plastic such as nylon), threaded holes, and threaded devices (e.g., bolts or screws) may be used to tighten components along the thermal path 314 to thereby provide a tight, compressed fit between the lid 302, thermoelectric cooler(s) 315, heat pipes 319, compression plate 316, and DAQ PCBA 310.

With reference to FIG. 52, in example embodiments, components of the main body 300 (such as in a portion of the lid 302) may be stacked as follows: (1) a top of the lid 302, (2) a thermal pad 318 and/or thermal paste or grease 388, (3) a TEC/lid interface, such as a compression plate 316 and in some examples including heat pipes 319 routed from contact with the TEC 315 to contact with the lid 302 (which in some examples may include grooves within the lid 302 itself), (4) the TEC 315, which in some examples may contact heat pipes 319, (5) a thermal pad and/or thermal paste or grease 388, (5) a TEC/DAQ PCBA interface, such as a compression plate 316, (6) a thermal pad 318 and/or thermal grease or paste 388 at the interface between the compression plate 316 and the DAQ PCBA 310, and (7) the DAQ PCBA 310. Underneath the DAQ PCBA 310, compression elements—such as including thermally insulative fasteners and washers discussed by example herein—may ensure a tight, thermally conductive fit between the DAQ PCBA 310 and the thermal path 314 provided by the components discussed above.

Meanwhile, with reference to FIGS. 49 and 51-52, at least one foam member 317 may thermally isolate portions of the compression plate 316 and/or portions of different ones of the plurality of compression plates 316 to avoid creating a thermal short, as the thermoelectric cooler(s) 315 works between a cold side and a hot side. For example, the foam member 317 may occupy a gap (e.g., of about 3 mm) between the compression plate 316 and the lid 302 to help support pressure against (and hence thermal conductivity between) the DAQ PCBA 310. Like as described above, the thermoelectric cooler(s) 315 may hot side connect to a top 304 of the lid 302 and provide a thermal path from the DAQ PCBA 310 to the finned portion 308. Additionally, with reference to FIGS. 49, 52, and 53, in some embodiments, at least two passive heat pipes 319 may be thermally connected to the at least one TEC 315 and to the lid 302 (e.g., through routing in a compression plate 316 and/or the lid 302 itself) and structured to dissipate heat away from the TEC 315 to sides of the lid 302. In an example, the lid 302 may include grooves 389 for the two heat pipes 319 (which, in one example, may be 70 mm) to fit therein. In an example, the at least two heat pipes 319 may extend in opposite directions from the TEC 315.

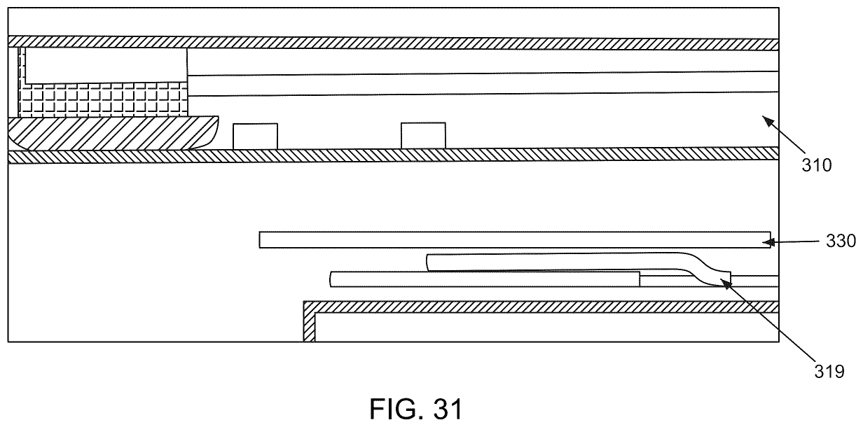

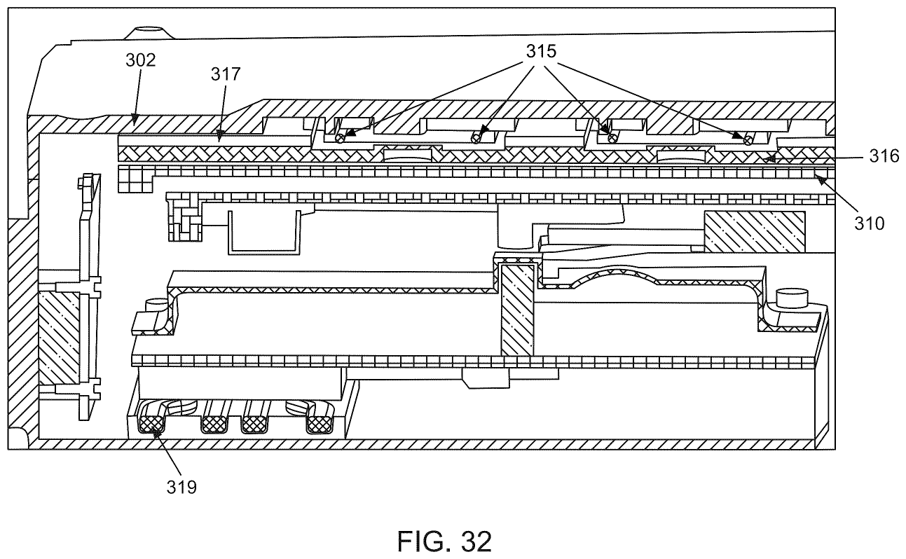

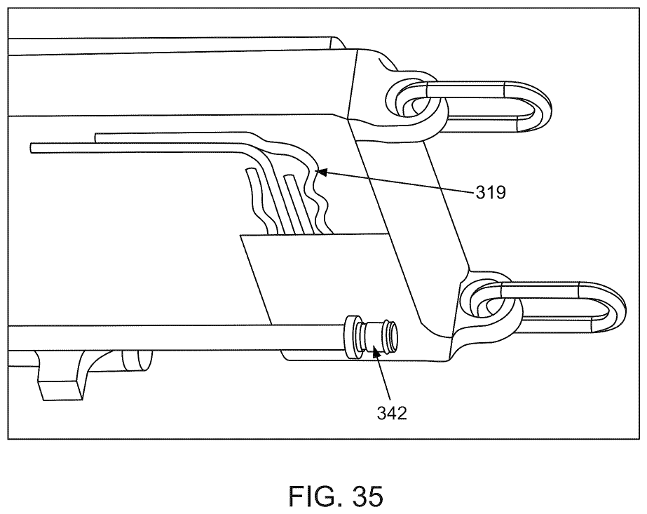

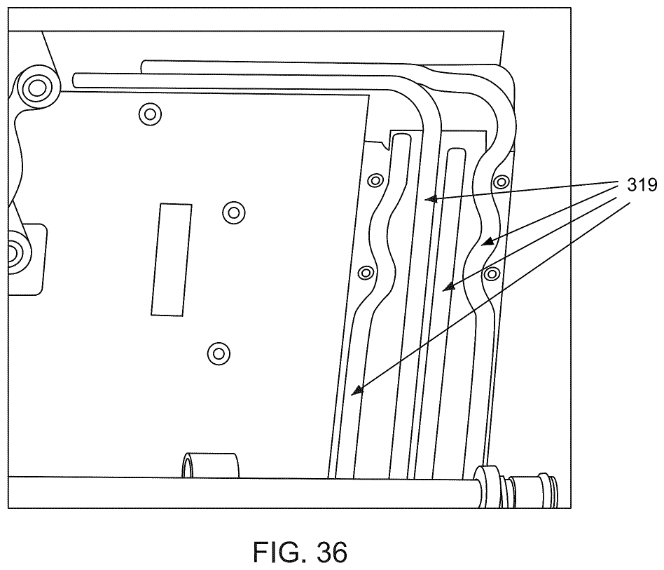

Meanwhile, in example embodiments, it may be sufficient for other electronic components of the main body 300, such as electronic PCBAs in the lower section 306, to be passively cooled. As illustrated by example in FIGS. 31-32 and 34-36, a plurality of passive heat pipes 319 may distribute heat generated (e.g., wick heat away) from at least some of the PCBAs to the metal housing 307. These PCBAs may include, for example, a PCBA 320 having a system-on-module (SOM) mounted thereon, as well as other PCBAs described with reference to FIG. 49. In an example embodiment, the SOM may include a compute module installed on the SOM PCBA 320 for additional computing power, to simplify wiring, and to provide general processing capabilities for future work.

As illustrated by example in FIGS. 33 and 49, the lid 302 may include at least one finned portion 308 including a plurality of fins for more quickly dissipating heat to the ambient temperature of the atmosphere. In some embodiments, other outside portions of the main body 300 may also include fins, such as the lower section 306. For example, with reference to FIG. 38, a finned portion 308 may be included on sides and the underside of lower section 306. In addition to cooling from the ambient temperature outside the main body 300, couplant fluid (e.g., water) may splash on the main body (including finned portion 308) during an inspection operation, providing a secondary manner of further cooling thereto. Through the use of the cooling structures described herein, the main body may maintain an adequate ΔT to sufficiently cool the electronic components therein.

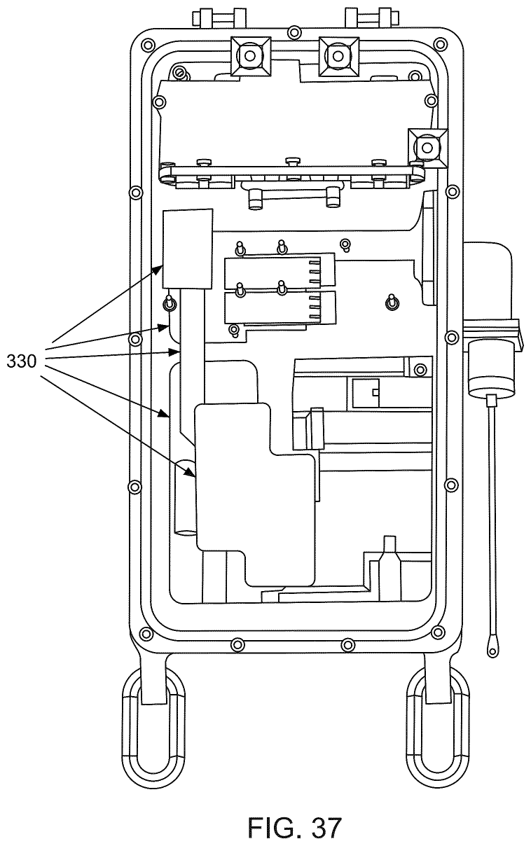

With reference to FIG. 37 and FIG. 49, other electronic components of the main body 300 may include a plurality of PCBAs 330, including a core PCBA 334, an add-on PCBA 337, a drive module (e.g., a drive module controller) PCBA 336 that may drive the drive modules 420, 440, 460, 480 as described by example herein, a power supply PCBA 332, and/or other PCBAs 338. In some embodiments, these other electronic components may be consolidated onto a single or multiple PCBAs.

The core PCBA 334 may include a core electronics package, which may be modified to suit various robotic needs, and which may be for core operations of the inspection robot. In some embodiments, the core PCBA 334 may be configured according to an inspection robot parameter of the inspection robot 110 to provide core processing operations for the inspection robot 110.

In some embodiments, the drive module PCBA 336 may be configured to control the at least one drive module of the inspection robot 110, as described by example herein, and may be swappable.

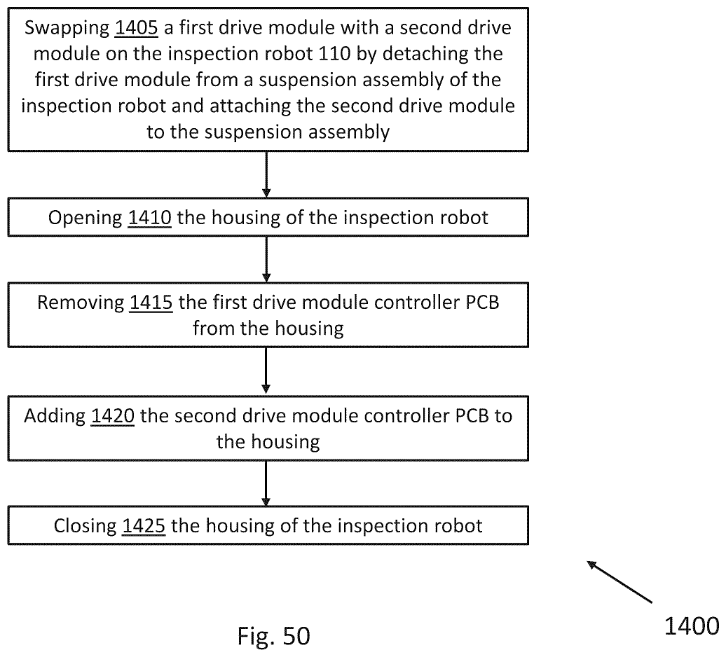

Indeed, with reference to FIG. 50, a method 1400 for changing drive functionalities of an inspection robot 110 according to example embodiments may include swapping 1405 a first drive module with a second drive module on the inspection robot 110 by detaching the first drive module from a suspension assembly 700 of the inspection robot 110 and attaching the second drive module to the suspension assembly 700. A housing 307 of a main body 300 of the inspection robot 110 may be attached to the suspension assembly 700 and may be structured for removing a first drive module controller PCBA 336 from the housing 307 and adding a second drive module controller PCBA 336, where the first drive module controller PCBA 336 may be configured to control the first drive module and the second drive module controller PCBA 336 may be configured to control the second drive module.

The method 1400 may further include opening 1410 the housing 307 of the inspection robot, removing 1415 the first drive module controller PCBA from the housing 307, adding 1420 the second drive module controller PCBA to the housing 307, and closing 1425 the housing 307 of the inspection robot 110.

In some examples, the first drive module may have a different drive capability than the second drive module, which may correspond to at least one of a power, a speed, a movement resolution, a movement precision, a wheel type, a wheel count, a payload mounting option, or a downforce option, and the second drive module controller PCBA may be swapped in to control the second drive module with the different drive capability.

In some examples, the first drive module may have a same drive capability as the second drive module, and the first drive module may be swapped with the second drive module for a service event (e.g., such as regular maintenance or a failure). Here, the first drive module controller may be configured to (e.g., capable of) control both the first and second drive modules.

With reference to FIG. 37 and FIG. 49, in some embodiments, the add-on PCBA 337 (which in some examples may include a plurality of PCBAs with different functions) may be configured to provide auxiliary processing operations for structural add-ons to the inspection robot 110. For example, the add-on PCBA 337 may include and/or interface with sensors used to detect operating conditions of the inspection robot 110 (e.g., a temperature sensor) and/or sensors used to collect data used for inspection—for example, an inertial measurement unit (IMU) to detect orientation of the inspection robot 110, or a hall sensor for magnetic readings. As another example, the add-on PCBA 337 may include or otherwise execute artificial intelligence/machine learning (AI/ML) on calibrations or sensing parameters for the inspection robot 110 to improve operation and/or sensing thereto, where such AI/ML may include at least one neural network and training thereof; special localization operations that reduce the burden on a main PCBA (e.g., the core PCBA 334) of the inspection robot 110; and/or auxiliary processing operations or operation of an auxiliary device that may not be commonly used.

In some embodiments, hardware or other components connected to the inspection robot 110, such as but not limited to hardware connected via the add-on PCBA 337, an expansion port 344 (as described by example herein), or otherwise, may have or be assigned (e.g., by the inspection robot 110) a hardware or serial number identification (ID). This hardware ID may be used by the inspection robot 110 and/off offsite from the inspection robot (e.g., at a base station connected to the inspection robot 110 via a tether) to query and manage configurations and other features of the inspection robot 110, such as to identify the inspection robot 110's inspection capabilities via the hardware ID and utilize the same.

Example and non-limiting auxiliary processing operations include operations such as: running an artificial intelligence, machine learning, or other iterative improvement operation on calibrations or other data collection parameters; performing complex operations to enhance the processing power (and/or to reduce the processing burden) of the main computing device, such as data compression, localization operations (e.g., operating a cost or other optimization function that determines the inspection robot location from a number of inputs that may not all agree with each other at all times, such as from dead reckoning inputs (e.g., the encoder), line of sight inputs, surface feature comparisons, triangulation-type calculations, etc.); operating an auxiliary device that may not be commonly utilized (e.g., a camera, LiDAR, actuator for repair, cleaning, and/or marking, etc.); sensors that detect the operating conditions and/or environment of the inspection robot (e.g., a sensor that is not used for inspection operations, such as a temperature sensor, humidity sensor, pressure sensor, etc.); and/or any special sensor (e.g., an inertial measurement unit, hall effect or other EMI sensor, and/or any other sensor requiring significant processing support beyond what is normally included between the DAQ and/or core PCBAs). In certain embodiments, an add-on PCBA 337 may be configured to provide a serial number and/or other identifier for connected hardware, which may be utilized to query and/or manage configurations and/or features of the inspection robot, provided in metadata to track with inspection data, to allow the core PCBA and/or a base station (e.g., a laptop accessible to the operator and at least intermittently communicatively coupled to the inspection robot, which allows an interface thereon to display the correct system and capabilities to the operator based on the actual configuration of the inspection robot) to determine available capabilities and provide appropriate displays to the operator and/or an analyst for the inspection operations.

In example embodiments, EMI shielding 309 may be provided inside the main body 300 between the DAQ PCBA 310 and the other electronic components including, for example, at least one other PCBA such as a drive module PCBA 336 or power supply circuitry included in a power supply PCBA 332. The EMI shielding 309 may be in the form of a film or plate and include a conductive and/or magnetic material. Additional shielding may also be provided for EMI frequencies including EMI frequencies not adequately attenuated by the metal housing 303 of the main body 300 and the EMI o-ring 301.

In examples, as the internal structure of the main body 300 may be compact and enclosed, the DAQ may be in close proximity to high voltage signals. As one example, the DAQ may be in close proximity to a power supply such as an AC/DC power supply on a power supply PCBA 332 inside the main body 300 (for example, in the lower section 306) that receives AC power from a tether and converts the power to a DC voltage. For example, the AC/DC power supply may receive an AC voltage from the tether and convert the voltage to a DC voltage for powering the inspection robot 110. As the DAQ may be a high speed/high frequency component, it may be more sensitive to noise (such as switching noise from the AC/DC power supply) than other electronic components inside the main body 300. Therefore, EMI shielding 309 inside the housing, such as between the DAQ PCBA 310 in the lid 302 and another one of the PCBAs in the lower section 306—which may, for example, include the power supply PCBA 332, a compute module circuit, or indeed, any or all of the PCBAs illustrated in the lower section 306 of FIG. 49, such as SOM PCBA 320, core PCBA 334, drive module PCBA 336, power supply PCBA 332, add-on PCBA 337, or other PCBAs 338—may mitigate noise that may negative impact the DAQ.

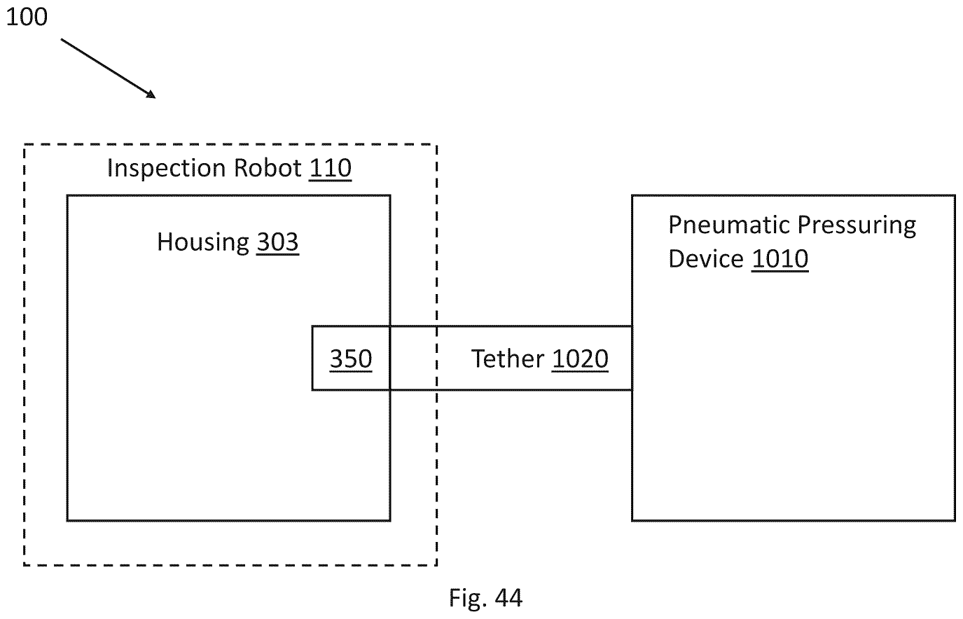

In example embodiments, the main body 300 may include port configurations that support modularity and enhanced capability. For example, with reference to FIG. 33, the main body 300 may include a plurality of ports, such as a side mounted tether interface 340 (which may also be referred to in example embodiments as a tether port) structured to connect to a tether for electrically communicating with a base station, for example by including an electrical interface for communicating over the tether to the base station. The tether interface 340 may be at a side of the main body 300 relative to a travel direction 110D of the inspection robot 110. The plurality of ports may include a rear mounted couplant interface 342, which may be structured to fluidly connect with a couplant tube, such as may be included with the tether, or for which fluid may be routed from the tether's connection to tether interface 340, so as to receive couplant therefrom. As shown in FIG. 38, the tether interface 340 may be structured to physically connect to the tether with one or more lugs 341. The plurality of ports may include an expansion port 344, which may be on a side of the main body 300. The plurality of ports may include an interface for driving a rear camera 348 and/or the rear camera itself. The interface for driving the camera and/or the rear camera itself may on a rear of the main body 300. The plurality of ports may include a fluid leak test port 350 in the housing 303 structured for application of a selected pressure to an interior of the housing 303. The leak test port 350 may be at a rear side of the main body 300 relative to the payload(s) 200 and/or the direction of travel 110D. Elsewhere herein, use of the leak test port 350 may be further described with reference to example embodiments such as shown in FIG. 44.

Additionally, as described with reference to example embodiments herein, the main body 300 may include a plurality of sensor ports for communicating with sensor packages such as the sensors (e.g., UT sensors) 240, which may be on the at least one payload 200 (e.g., via the first and second main cables 260 and 265). In an example, such ports may be on a front side of the main body 300. Additionally, the main body 300 may include, for example on the front side, at least one camera port for communicating with at least one camera, such as front cameras such as cameras 280 and 285. In an example, the at least one camera may be on the at least one payload 200.

The expansion port 344 may provide expansion capabilities by providing ethernet communication capabilities and/or power from the main body, such as 12 VDC power. Additionally, the expansion port interface plate may be replaced as desired with a panel providing different interface capabilities, depending on a desired use case. The expansion port 344 may provide a way to expand on the system 100 without a need to redesign the main body 300.

As described herein, the tether port 340 may connect to a tether (not shown) for communicating (e.g., electrically) with a base station and receiving couplant fluid. For example, as described by example herein, the tether port 340 may be structured to send digital sensor signals to the base station that have been converted from analog signals by the DAQ.

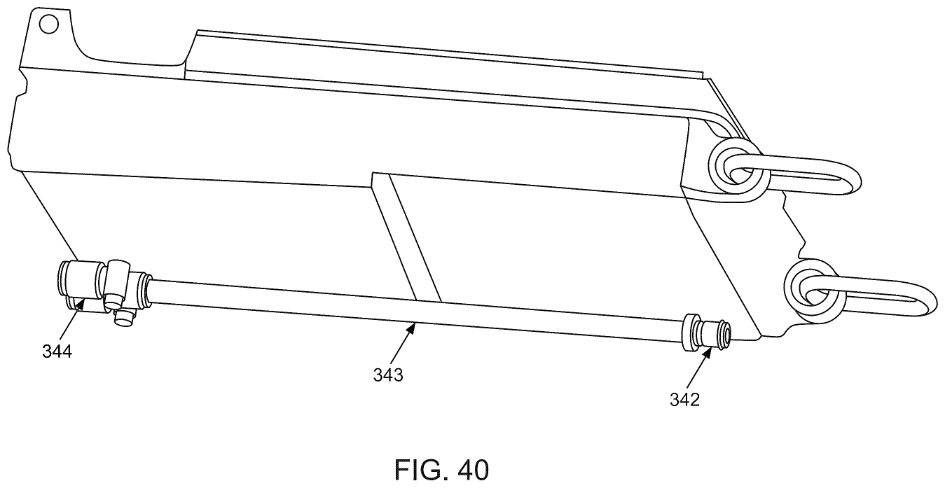

With reference to FIG. 40, in example embodiments, the rear mounted couplant interface 342, which may be structured to couple to couplant fluid provided by a tether, may be in or otherwise at or attached to main body 300. The couplant interface 342 may be attached to a main couplant tube 343. Main couplant tube 343, which may be in or otherwise at or attached to main body 300, such as a bottom of the main body 300, may transport couplant fluid provided by the tether to connector 344, which in some embodiments may provide the couplant fluid to each sensor sled 230 through individual tubes 345, or through larger tubes that run to manifolds at the sensor sled assemblies where the couplant fluid is distributed via individual tubes 345 to each sensor sled 230. In some embodiments, one or more tubes distributing couplant fluid from main couplant tube 343 to the sensor sleds 230 may run through chain housing 262 or 267, but embodiments are not limited thereto, and in some embodiments, tubes may run directly or via manifolds from the main couplant tube 343 to each sensor sled 230.

In example embodiments, with reference to FIG. 38, the fluid leak test port 350 may be provided on a rear side of the main body 300 (e.g., relative to payload(s) and/or a travel direction 110D of the inspection robot 110). The leak test port 350 may include a seal and may be structured to connect to a pneumatic pressuring device such as a mass flow meter, e.g., via a tube, that pressurizes the interior of the main body 300 to a specified pressure before checking for leaks. This may be a part of a quality control process used to inspect an inspection robot 110 prior to operation in the field. FIG. 39 illustrates an example fluid test port 350 that has been made partially transparent to show its details.

In some embodiments, with reference to FIG. 44, the inspection robot system 100 may further include a pneumatic pressuring device 1010 and a tether 1020 including a tube structured to connect between the leak test port 350 and the pneumatic pressuring device 1010. In some examples, the pneumatic pressuring device 1010 may be configured to pressurize the interior of the housing 303 of the inspection robot 110 to the selected pressure to check for leaks. The pneumatic pressuring device 1010 may, for example, be a mass flow meter.

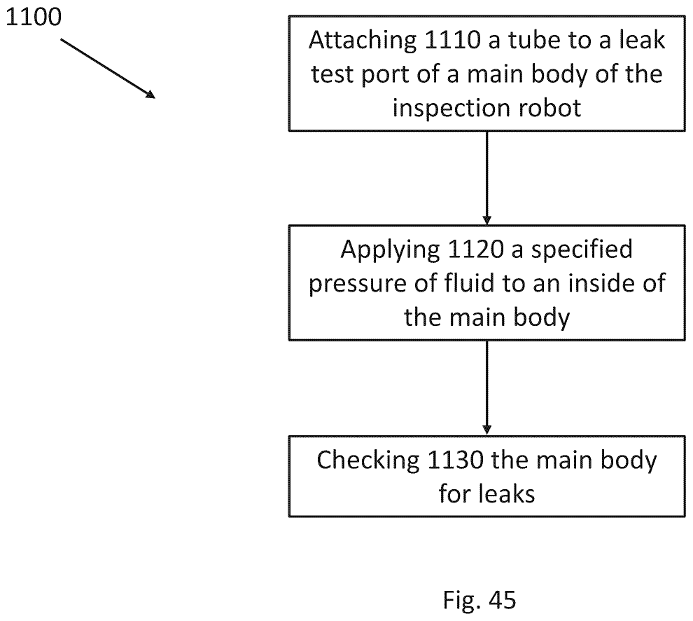

In some embodiments, with reference to FIG. 45, a method 1100 for leak testing an inspection robot 110 may include attaching 1110 a tube (e.g., as part of a tether 1020) to a leak test port 350 of a main body 300 of the inspection robot 110. The leak test port 350 may be at a rear side of the main body 300, and the inspection robot 110 may include a payload 200 (which may include a plurality of payloads 200) having a plurality of ultrasonic (UT) sensors 240 on a front side of the main body 300 for inspecting an inspection surface 101. The front side of the main body 300 may be opposite to the rear side of the main body 300.

The method 1100 may further include applying 1120 a specified pressure of fluid to an inside of the main body 300 through the tube attached to the leak test port 350. In an example, the specified pressure of fluid may be applied by a pneumatic pressuring device 1010 such as a mass flow meter, and the fluid may be a gas (e.g., air or an inert gas) to avoid damaging circuitry inside the main body 300.

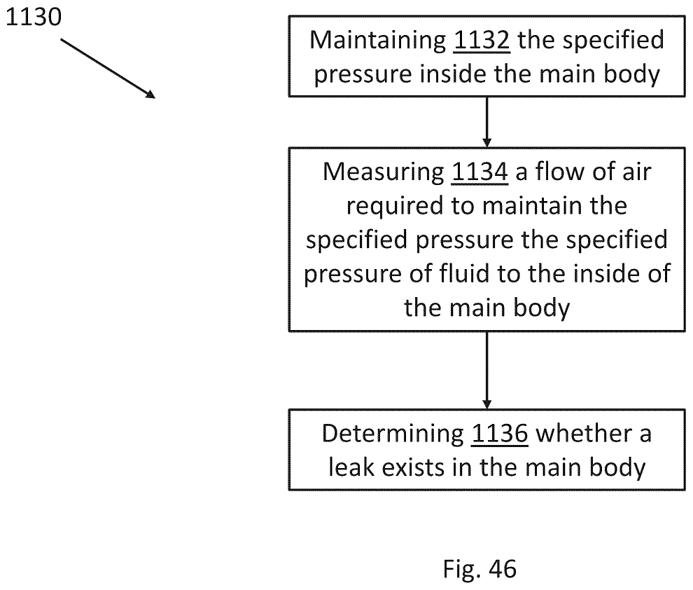

The method 1100 may further include checking 1130 the main body 300 for leaks. For example, with reference to FIG. 46, checking 1130 the main body 300 for leaks may include maintaining 1132 the specified pressure inside the main body 300, e.g., by causing a pressure regulator of the pneumatic pressuring device 1010 (such as a mass flow meter) to maintain the specified pressure. While the specified pressure is being maintained, a flow of air required to maintain the specified pressure inside the main body 300 may be measured 1134, e.g., by a sensor of the pneumatic pressuring device 1010. Based on comparing the required flow of air to a threshold, it may be determined 1136 whether or not a leak exists in the main body 300. For example, if the required flow of air is at or below the threshold (e.g., a lower amount of flow of air is required), it may be determined that there is no leak, whereas if the required flow of air is above the threshold, it may be determined that a leak exists. Furthermore, a severity of the leak may be determined based on the measured required amount of air above the threshold. In certain embodiments, the leak test may be determined in response to maintaining a selected pressure in the inspection robot, and determining the mass flow of air required to maintain the selected pressure (e.g., where a relatively high mass flow of air indicates a leak and/or unacceptable level of sealing), and/or sweeping the maintained pressure through a range or sequence of pressures (e.g., to determine pressure dependent leakage) and determining the leak and/or sealing aspect according to mass flow required to perform the pressure sweep.

However, embodiments are not limited thereto, and in some examples, checking 1130 the main body 300 for leaks may include fluidly connecting a pressure sensor to the leak test port (which in some examples may be a part of pneumatic pressuring device 1010), removing the specified pressure of fluid to the inside of the main body 300, and analyzing, based on a sensing from the pressure sensor, a pressure drop characteristic of a pressure inside the main body. The pressure drop characteristic may include a time for the pressure inside the main body to drop to a threshold amount of pressure or, for example, whether an amount of pressure at a given time after removing the specified pressure is above or below a threshold, and determining therefrom that there is a leak. Furthermore, in some examples, a curve of the pressure drop over time may be compared to the pressure drop curve of a no-leak example and/or to the pressure drop curves of one or more leak examples to determine whether there is a leak in the main body 300.

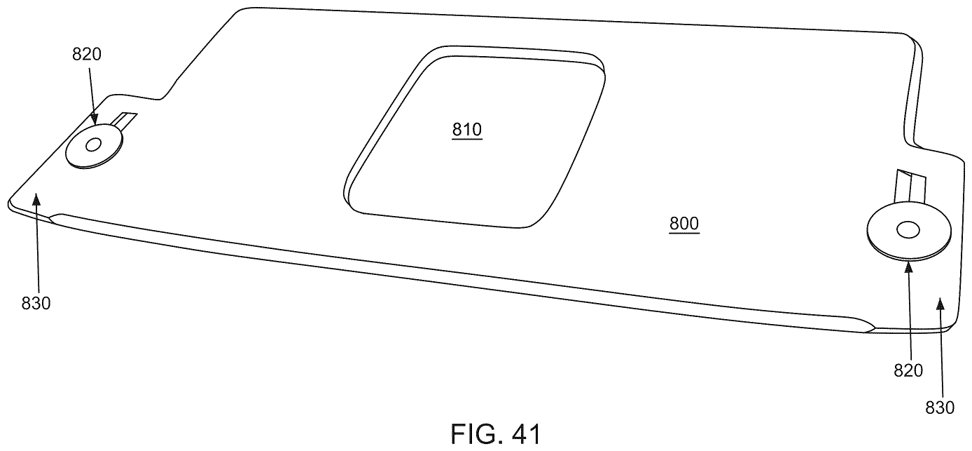

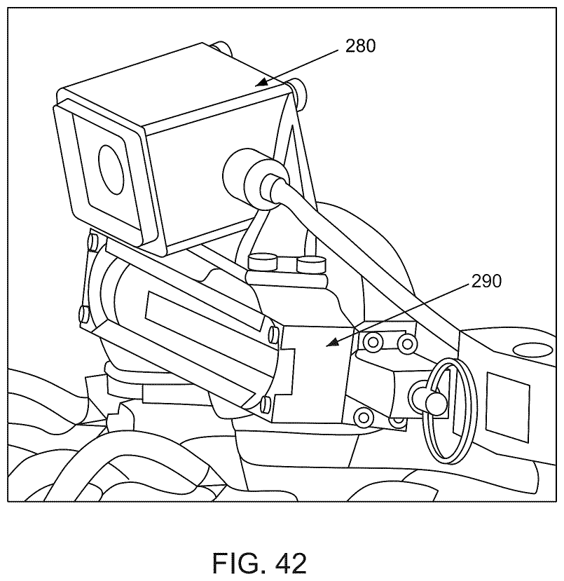

With reference to FIG. 41, in example embodiments, the system 100 may include a robot removal platform 800 for removing an inspection robot 110 from an inspection surface 101. The robot removal platform 800 may have a generally flat shape (e.g., like a mat) such that an inspection robot 110 may roll onto the robot removal platform 800 from an inspection surface. The robot removal platform may include one or more magnets 820 so that the robot removal platform 800 may adhere to the inspection surface 101, and the robot removal platform 800 may be made of a flexible polymer having the flat shape and with a metallic mesh therein that allows the robot removal platform 800 to adhere to the inspection robot 110, e.g., with its magnetic wheels 510 as described by example herein, when the inspection robot 110 is removed from the inspection surface 101. However, the robot removal platform 800 may have a thickness (e.g., in a direction orthogonal to the inspection surface 101) such that the inspection robot 110 is adequately displaced from the inspection surface 101 (which may be ferromagnetic) for its manual removal (e.g., together with the platform 800 itself) by a human user.

In some examples, the robot removal platform 800 may include at least one beveled end for the inspection robot 110 to easily roll from the inspection surface 101 onto the robot removal platform 800. For example, at least one end of the platform 800 may be tapered. Further, in some examples, the thickness of the robot removal platform 800 (or, more specifically, its flexible polymer) may be variable in order to provide for a variable required lift-off force for manual removal of the inspection robot 110 and, in some examples, the platform 800 as well. For example, the thicker the platform 800, the less force required to overcome the magnetic force between magnetic wheels 510 of inspection robot 110 and the ferromagnetic inspection surface 101. Additionally, in some examples, the robot removal platform 800 may include at least one extended portion 830 that is structured to extend beyond the magnetic wheels 510 of the inspection robot 110 when the inspection robot 110 is on the robot removal platform 800 to thereby provide a lever arm for removing the robot removal platform 800 and the inspection robot 110 from the inspection surface 101. In some examples, the platform 800 may include two extended portions 830 at opposite ends of the platform 800.

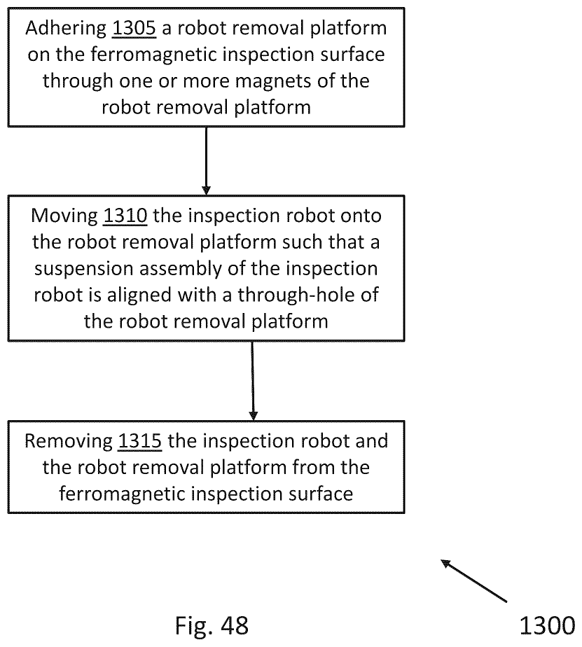

Thus, with reference to FIG. 48, according to example embodiments, a method 1300 of removing an inspection robot from a ferromagnetic inspection surface may include adhering 1305 the robot removal platform to the ferromagnetic inspection surface 101 by one or more magnets 820 of the robot removal platform 800 (e.g., on the flexible polymer). The method 1300 may include moving 1310 the inspection robot 110 onto the robot removal platform 800 such that a suspension assembly 700 of the inspection robot 110 is aligned with a through-hole 810 of the robot removal platform. For example, the drive modules of the inspection robot 110 may roll the inspection robot onto the robot removal platform 800. The method 1300 may include removing 1315 the inspection robot 110 and the robot removal platform 800 from the ferromagnetic inspection surface 101.

Afterwards, a through-hole 810 in the robot removal platform 800 according to example embodiments is structured to provide access to the suspension assembly 700 of the inspection robot 110 when the inspection robot 110 is on the robot removal platform 800 so that a user can easily carry the inspection robot 110.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. The term “set” may include a set with a single member. No language in the specification should be construed as indicating any non-claimed element as essential to the practice of the disclosure.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g. where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

Certain operations, determinations, and/or functions related to methods and systems described herein may be deployed in part or in whole through a machine having a computer, computing device, processor, and/or circuit, that executes computer readable instructions, program codes, instructions, and/or includes hardware configured to functionally execute one or more operations of the methods and systems disclosed herein. The terms computer, processor, circuit, PCB, and/or PCBA, as utilized herein, should be understood broadly.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure.

1-119. (canceled)

120. An inspection robot system for inspecting an inspection surface, comprising:
a main body including a housing;
a payload including a plurality of sled assemblies, the sled assemblies including at least one sled structured to interface with the inspection surface and to house an ultrasonic (UT) sensor for inspecting the inspection surface;
at least one junction box on the payload and including a plurality of assembly connectors to connect to the plurality of sled assemblies;
a plurality of sled assembly cables each structured to transmit signals for respective ones of the UT sensors between one of the assembly connectors of the at least one junction box and a respective one of the plurality of sled assemblies; and
at least one cable connected between the at least one junction box and the main body for electrical communications therebetween, the electrical communications including signals for the UT sensors housed by respective at least one sleds of the plurality of sled assemblies,
wherein the at least one junction box is configured to route the signals for the UT sensors between the at least one cable and the plurality of assembly connectors.

121. The inspection robot system of claim 120, wherein:
the plurality of sled assemblies includes a first plurality of sled assemblies;
the at least one junction box includes a first junction box;
the at least one cable includes a first cable connected between the main body and the first junction box, the first cable structured to transmit signals for a first plurality of the UT sensors, which are respectively housed by a first plurality of sleds of the first plurality of sled assemblies; and
the first junction box includes:
a first junction box connector structured to connect to the first cable;
assembly connectors for each of the first plurality of the plurality of sled assemblies; and
a first junction box printed circuit board structured to route the signals for the first plurality of the UT sensors between the first cable and the respective assembly connectors for each of the first plurality of sled assemblies.

122. The inspection robot system of claim 121, wherein:
the plurality of sled assemblies further includes a second plurality of sled assemblies;
the at least one junction box further includes a second junction box;
the at least one cable further includes a second cable connected between the main body and the second junction box, the second cable structured to transmit signals for a second plurality of the UT sensors, which are respectively housed by a second plurality of sleds of the second plurality of sled assemblies; and
the second junction box includes:
a second junction box connector structured to connect to the second cable;
assembly connectors for each of the second plurality of the plurality of sled assemblies; and
a second junction box printed circuit board structured to route the signals for the second plurality of the UT sensors between the second cable and the respective assembly connectors for each of the second plurality of sled assemblies.

123. The inspection robot system of claim 122, wherein:
the first plurality of sleds includes twelve sleds, and the second plurality of sleds include twelve sleds;
the first plurality of sled assemblies includes four sled assemblies each having three sleds; and
the second plurality of sled assemblies includes four sled assemblies each having three sleds.

124. The inspection robot system of claim 120, further comprising:
at least one chain housing structured to contain the at least one cable therein.

125. The inspection robot system of claim 124, wherein the at least one chain housing is flexible and includes a sequence of rectangular chain links.

126. The inspection robot system of claim 120, further comprising:
a cable routing means for routing and protecting the at least one cable.

127. The inspection robot system of claim 120, wherein the at least one junction box routes the signals for the UT sensors according to a routing ratio parameter.

128. The inspection robot system of claim 127, wherein the routing ratio parameter is one cable to four assembly connectors.

129. The inspection robot system of claim 120, wherein the at least one junction box includes a printed circuit board with traces that provide direct electrical connections between the at least one cable and the plurality of assembly connectors.

130. An inspection robot system for inspecting an inspection surface, comprising:
a main body including a housing;
a payload including a plurality of sled assemblies, the sled assemblies including at least one sled structured to interface with the inspection surface and to house an ultrasonic (UT) sensor for inspecting the inspection surface,
wherein the plurality of sled assemblies includes a first plurality of sled assemblies and a second plurality of sled assemblies;
at least one junction box on the payload and including a plurality of assembly connectors to connect to the plurality of sled assemblies,
wherein the at least one junction box includes a first junction box and a second junction box; and
at least one cable connected between the at least one junction box and the main body for electrical communications therebetween, the electrical communications including signals for the UT sensors housed by respective at least one sleds of the plurality of sled assemblies,
wherein the at least one cable includes:
a first cable connected between the main body and the first junction box, the first cable structured to transmit signals for a first plurality of the UT sensors, which are respectively housed by a first plurality of sleds of the first plurality of sled assemblies; and
a second cable connected between the main body and the second junction box, the second cable structured to transmit signals for a second plurality of the UT sensors, which are respectively housed by a second plurality of sleds of the second plurality of sled assemblies;
wherein the first junction box includes:
a first junction box connector structured to connect to the first cable;
assembly connectors for each of the first plurality of the plurality of sled assemblies; and
a first junction box printed circuit board structured to route the signals for the first plurality of the UT sensors between the first cable and the respective assembly connectors for each of the first plurality of sled assemblies;
wherein the second junction box includes:
a second junction box connector structured to connect to the second cable;
assembly connectors for each of the second plurality of the plurality of sled assemblies; and
a second junction box printed circuit board structured to route the signals for the second plurality of the UT sensors between the second cable and the respective assembly connectors for each of the second plurality of sled assemblies; and
wherein the at least one junction box is configured to route the signals for the UT sensors between the at least one cable and the plurality of assembly connectors.

131. The inspection robot system of claim 130, further comprising:
at least one chain housing structured to contain the at least one cable therein.

132. The inspection robot system of claim 131, wherein the at least one chain housing is flexible and includes a sequence of rectangular chain links.

133. The inspection robot system of claim 132, further comprising:
a cable routing means for routing and protecting the at least one cable.

134. The inspection robot system of claim 133, wherein the at least one junction box routes the signals for the UT sensors according to a routing ratio parameter.

135. The inspection robot system of claim 134, wherein the routing ratio parameter is one cable to four assembly connectors.

136. The inspection robot system of claim 130, wherein the at least one junction box includes a printed circuit board with traces that provide direct electrical connections between the at least one cable and the plurality of assembly connectors.

137. The inspection robot system of claim 130, wherein:
the first plurality of sleds includes twelve sleds, and the second plurality of sleds include twelve sleds;
the first plurality of sled assemblies includes four sled assemblies each having three sleds; and
the second plurality of sled assemblies includes four sled assemblies each having three sleds.
